(19) United States
(12) Patent Application Publication
(10) Pub. No.: US 2025/0335791 A1
(43) Pub. Date: Oct. 30, 2025

(54) DEVICES, SYSTEMS, AND METHODS FOR ASSESSING FOOD PRODUCTS

(71) Applicant: Clara Foods Co., Daly City, CA (US)

(72) Inventors: Zachary FRIAR, Daly City, CA (US); Varsha GOPALAKRISHNAN, Daly City, CA (US); Dane JACOBSON, Daly City, CA (US); Kritika MAHADEVAN, Daly City, CA (US); Ranjan PATNAIK, Daly City, CA (US); Weixi ZHONG, Daly City, CA (US)

(73) Assignee: Clara Foods Co., Daly City, CA (US)

(21) Appl. No.: 19/190,228

(22) Filed: Apr. 25, 2025

Related U.S. Application Data
(60) Provisional application No. 63/638,429, filed on Apr. 25, 2024.

(51) Int. Cl. G06N 5/022

(52) U.S. Cl. CPC G06N 5/022

(57) ABSTRACT

Disclosed are devices, systems, and methods for assessing food products and predicting product performance or quality of a food product. The disclosure includes spectrometers, measuring devices, computing devices, data management systems, machine learning models, etc. The system can obtain the FTIR data associated with generation of food products and process the FTIR data using one or more machine learning models to generate a prediction of performance or quality of the food products when incorporated into one or more applications for consumption as food and/or beverage.

### BACKGROUND

Traditional methods of evaluating food product quality often rely on time-consuming laboratory tests and subjective sensory evaluations, which may not provide real-time or predictive insights.

Recent advancements in spectroscopy have enabled more efficient methods for assessing product characteristics. In particular, Fourier-transform infrared (FTIR) spectroscopy has emerged as a valuable tool for analyzing the chemical composition of food products.

There exists a need for integrated systems that can efficiently collect, process, and analyze spectroscopic data to predict the performance or quality of food products prior to their consumption. Such systems can enhance decision-making in production environments, reduce waste, and improve overall product consistency.

### SUMMARY

Aspects of the present disclosure include systems and devices utilizing machine learning algorithms and spectral training datasets to accurately predict the quality and performance of food products.

Advances in modern chemistry and biological sciences have made it possible to synthesize biological products for wide-ranging food applications, for example, plant-based eggs, lab-grown meat, improved baking yeast, and nutritional supplements, to reduce the need for factory farming and carbon-intensive food production. In some instances, combining ingredients the same way (e.g., same ingredients, same recipe) in a synthesized product may not lead to the same results obtained from a naturally occurring product. It may be time-consuming and costly to enlist experts to manually test these synthesized products.

There is a need to quickly and cheaply determine the effectiveness with which synthesized proteins may be substituted in food products. Provided herein are systems and methods for using machine learning to predict performance and/or quality measures for applications comprising uses of synthesized proteins in various food items.

Disclosed is a method for predicting product performance or quality by obtaining data associated with the generation of one or more products. The obtained data included Fourier transform infrared (FTIR) data. The method further includes processing the data using one or more machine-learning models to generate a prediction of performance or quality of the one or more products when incorporated into one or more applications for consumption as food and/or beverage.

The application may be a plurality of different applications for Protein A and Protein B proteins and the one or more products may include at least one product in powder form. The application may be at least one food application or food type and the one or more products may be used as a binder in the food application or food type. Examples of food applications or food types include a food bar, broth, chocolate, meringue, pound cake, scramble, or burger binding. The application may be at least one beverage application or beverage type and the one or more products may be used as a neutral protein in the beverage application or beverage type. Examples of beverage applications or beverage types include coffee, tea, coconut water, non-dairy milk, or juice.

The prediction of performance quality may include one or more scores associated with one or more attributes for the one or more applications. The one or more scores are predictive of a level of acceptance, acceptability or satisfaction to a group of consumers of the one or more applications for consumption as a food and/or beverage. The one or more attributes includes sensory attributes associated with sensory perception of the one or more applications. The one or more attributes include functionality attributes associated with the incorporation of the one or more products into the one or more applications. In one embodiment, functionality attributes relate to cooking functionality including gelation, foaming, scrambling, baking, cooking experience, or the appearance of food or beverage applications during preparation. Examples of sensory attributes include flavor, texture, mouth feel, taste, odor, or appearance. In some embodiments, attributes may be expert ratings, sensory panels determined from normalized degrees of difference, or related to the functionality ratings. The prediction of performance or quality may be generated independent of, without using, or prior to use of a human sensor panel.

The FTIR data comprises FTIR spectra of at least one powdered product, at least one aqueous product, and/or at least one product comprising a powder and aqueous mixture. The obtained data may include rheological data. The obtained data may further comprise strong cation exchange (SCX) chromatography data. In one embodiment, the FTIR data is unaugmented. In one embodiment, the FTIR data is augmented with synthetically generated data comprising simulated FTIR spectra and/or simulated noise. The synthetically generated data may be generated using a sampling algorithm, for example Synthetic Minority Over-sampling Technique (SMOTE).

The one or more machine learning models are generated based, at least in part on, a plurality of features, an importance level or weight of each feature, and interactions between different features (e.g., causal inference or relationships). Examples of features include two or more of an FTIR spectrum, DSP quality, USP quality, flavor, or powder quality. The classification machine learning models may comprise one or more classification models, for example AdaBoost, K-nearest neighbor, random forest, decision tree, support vector, or a neural network. Regression methods may include elastic net regression, support vector regression (SVR), random forest regression, and/or generative additive models (GAM s), AdaBoost with regression trees, partial least squares (PLS), and principal components regression (PCR), or a neural network. In one embodiment, the machine learning models include at least one model trained, in part, using sensory data. In one embodiment, the machine learning models include at least one model that is not trained using any sensory data. In one embodiment, FTIR spectra data from DSP streams is used to predict a quality metric. For example, during a filtration step where molecule byproducts are removed from a product, a machine-learning model may predict poor quality in a range of applications so that an operator can apply the further DSP processing to the product until the predicted quality satisfies thresholds for the range of applications.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a system for predicting product performance or quality from analysis of Fourier transform infrared spectroscopy (FTIR) data associated with generation of the product;

FIG. 1B illustrates how the model training pipeline of FIG. 1 performs continuous learning;

FIG. 2 is a process 200 for predicting product performance or quality from analysis of FTIR data associated with generation of the product;

FIG. 3 illustrates an end-to-end modeling including various interactive features for product performance prediction;

FIG. 4 illustrates compositions of training dataset and validation dataset for predicting the performance of Protein A protein when incorporated into coffee beverage;

FIG. 5A illustrates a confusion matrix representing a multi-class classification of being unacceptable, being acceptable and being great for Protein A protein incorporated into coffee beverage in the validation dataset, predicted by AdaBoost model;

FIG. 5B lists a multi-class classification of being unacceptable, being acceptable and being great for Protein A protein incorporated into coffee beverage in the validation dataset, predicted by AdaBoost model;

FIG. 6A illustrates a confusion matrix representing a binary classification of being unacceptable and being acceptable for Protein A protein incorporated into coffee beverage in the validation dataset, predicted by AdaBoost model;

FIG. 6B lists the binary classification of being unacceptable and being acceptable for Protein A protein incorporated into coffee beverage in the validation dataset, predicted by AdaBoost model;

FIG. 7 lists the accuracy for binary and multi-class classification of Protein A protein incorporated into coffee beverage using various machine learning models;

FIG. 8 lists the accuracy for binary and multi-class classification of Protein A protein incorporated into coffee beverage using various machine learning models when human sensory features are excluded;

FIG. 9A illustrates feature importance for multi-class classification using AdaBoost model to predict the performance of Protein A protein incorporated into coffee beverage;

FIG. 9B illustrates feature importance for binary classification using AdaBoost model to predict the performance of Protein A protein incorporated into coffee beverage;

FIG. 10 illustrates compositions of training dataset and validation dataset for predicting the performance of Protein A protein when incorporated into coconut water;

FIG. 11 lists the accuracy for binary classification of Protein A protein incorporated into coconut water using various machine learning models;

FIG. 12A illustrates a confusion matrix representing binary classification of being unacceptable and being acceptable/good for Protein A protein incorporated into coconut water in the validation dataset, predicted by AdaBoost model;

FIG. 12B lists the binary classification of being unacceptable and being acceptable/good for Protein A protein incorporated into coconut water in the validation dataset, predicted by AdaBoost model;

FIG. 13 lists the accuracy for the binary classification of being unacceptable and being acceptable/good for Protein A protein incorporated into coconut water using various machine learning models, when human sensory features are excluded;

FIG. 14 illustrates feature importance for multi-class classification using AdaBoost model to predict the performance of Protein A protein incorporated into coconut water;

FIG. 15 illustrates total sample count by non-dairy milk category;

FIG. 16 illustrates compositions of training dataset and validation dataset for predicting the performance of Protein A protein when incorporated into non-dairy milk;

FIG. 17 lists the accuracy for binary and multi-class classification of Protein A protein incorporated into non-dairy milk using various machine learning models;

FIG. 18A illustrates a confusion matrix representing a multi-class classification of being unacceptable, being acceptable and being great for Protein A protein incorporated into non-dairy milk in the validation dataset, predicted by a k-nearest neighbors (k-NN) model;

FIG. 18B illustrates a confusion matrix representing a binary classification of being unacceptable and being acceptable for Protein A protein incorporated into non-dairy milk in the validation dataset, predicted by a k-NN model;

FIG. 19 lists the accuracy for multi-class classification and binary classification for Protein A protein incorporated into non-dairy milk in the validation dataset using various machine learning models, when human sensory features are excluded;

FIG. 20A illustrates a confusion matrix representing multi-class classification of being unacceptable, being acceptable and being great for Protein A protein incorporated into non-dairy milk in the validation dataset when human sensory features are excluded, predicted by k-NN model;

FIG. 20B illustrates a confusion matrix representing a binary classification of being unacceptable and being acceptable for Protein A protein incorporated into non-dairy milk in the validation dataset when human sensory features are excluded, predicted by k-NN model;

FIG. 21 illustrates compositions of training dataset and validation dataset for predicting the performance of Protein A protein incorporated into a date bar;

FIG. 22A illustrates unbalanced natural segmentation of data into being unacceptable and acceptable;

FIG. 22B illustrates adjusted and balanced segmentation of data into being great and not great;

FIG. 23 lists the accuracy for multi-class classification and binary classification for Protein A protein incorporated into date bar in the validation dataset using various machine learning models;

FIG. 24 illustrates feature importance for binary classification using AdaBoost model to predict the performance of Protein A protein incorporated into a date bar;

FIG. 25A illustrates a confusion matrix representing a multi-class classification of being unacceptable, being acceptable and being great for Protein A protein incorporated into date bar in the validation dataset, predicted by k-NN model;

FIG. 25B illustrates a confusion matrix representing a binary classification of being “not great” and being “great” for Protein A protein incorporated into date bar in the validation dataset, predicted by k-NN model;

FIG. 26 the accuracy for multi-class classification and binary classification for Protein A protein incorporated into date bar in the validation dataset using various machine learning models, when human sensory features are excluded;

FIG. 27A illustrates a confusion matrix representing a multi-class classification of being unacceptable, being acceptable and being great for Protein A protein incorporated into date bar in the validation dataset predicted by k-NN model, excluding human sensory features;

FIG. 27B illustrates a confusion matrix representing a binary classification of being “not great” and being “great” for Protein A protein incorporated into date bar in the validation dataset, predicted by k-NN model, excluding human sensory features;

FIG. 28 compares the training accuracy and validation accuracy for predicting the performance of Protein A protein incorporated into various applications, using a full feature list for machine learning models to predict and a feature list removing human sensory features, respectively;

FIG. 29 compares the training accuracy and validation accuracy for predicting the performance of Protein A protein incorporated into various applications, using FTIR data for machine learning models to predict and additionally strain information of the Protein A protein, respectively;

FIG. 30 is a summary of application ratings determined by subject area experts, where various applications are incorporated with Protein B protein from different manufacture batches;

FIG. 31 illustrates compositions of training dataset and validation dataset for predicting the performance of Protein B protein incorporated into pound cake;

FIG. 32A illustrates a confusion matrix representing a multi-class classification of being unacceptable, being acceptable and being great for the performance of Protein B protein incorporated into pound cake in the validation dataset, predicted by logistic regression model;

FIG. 32B illustrates a confusion matrix representing a binary classification of being unacceptable and being acceptable for the performance of Protein B protein incorporated into pound cake in the validation dataset, predicted by logistic regression model;

FIG. 33A illustrates a confusion matrix representing a multi-class classification of being unacceptable, being acceptable and being great for the performance of Protein B protein incorporated into pound cake in the validation dataset, predicted by Support vector classifier (SVC) model;

FIG. 33B illustrates a confusion matrix representing a binary classification of being unacceptable and being acceptable for the performance of Protein B ovalbumin (Protein B) protein incorporated into pound cake in the validation dataset, predicted by SVC model;

FIG. 34A illustrates a confusion matrix representing a multi-class classification of being unacceptable, being acceptable and being great for the performance of Protein B protein incorporated into pound cake in the validation dataset, predicted by K-nearest neighbors (k-NN) model;

FIG. 34B illustrates a confusion matrix representing a binary classification of being unacceptable and being acceptable for the performance of Protein B protein incorporated into pound cake in the validation dataset, predicted by k-NN model;

FIG. 35A illustrates a confusion matrix representing a multi-class classification of being unacceptable, being acceptable and being great for Protein B protein incorporated into pound cake in the validation dataset, predicted by decision tree model;

FIG. 35B illustrates a confusion matrix representing a binary classification of being unacceptable and being acceptable for Protein B protein incorporated into pound cake in the validation dataset, predicted by a decision tree model;

FIG. 36A illustrates a confusion matrix representing a multi-class classification of being unacceptable, being acceptable and being great for Protein B protein incorporated into pound cake in the validation dataset, predicted by a random forest model;

FIG. 36B illustrates a confusion matrix representing a binary classification of being unacceptable and being acceptable for Protein B protein incorporated into pound cake in the validation dataset, predicted by a random forest model;

FIG. 37A illustrates a confusion matrix representing a multi-class classification of being unacceptable, being acceptable and being great for Protein B protein incorporated into pound cake in the validation dataset, predicted by an AdaBoost model;

FIG. 37B illustrates a confusion matrix representing a binary classification of being unacceptable and being acceptable for Protein B protein incorporated into pound cake in the validation dataset, predicted by an AdaBoost model;

FIG. 38 lists the accuracy for binary and multi-class classification for Protein B protein incorporated into pound cake using various machine learning models;

FIG. 39 lists compositions of collected sensory dataset as training dataset and validation dataset for predicting the performance of Protein B protein incorporated into a pound cake;

FIG. 40A illustrates a confusion matrix representing a multi-class classification of being unacceptable, being acceptable and being great for Protein B protein incorporated into pound cake in the collected sensory validation dataset, predicted by a logistic regression model;

FIG. 40B illustrates a confusion matrix representing a binary classification of being unacceptable and being acceptable for Protein B protein incorporated into pound cake in the collected sensory validation dataset, predicted by a logistic regression model;

FIG. 41 lists the accuracy for binary and multi-class classification of Protein B protein incorporated into pound cake in the collected sensory validation dataset using various machine learning models;

FIG. 42 lists compositions of collected sensory dataset as training dataset and validation dataset after SMOTE for predicting the performance of Protein B protein incorporated into pound cake;

FIG. 43A illustrates a confusion matrix representing a multi-class classification of being unacceptable, being acceptable and being great for Protein B protein incorporated into pound cake in the balanced validation dataset after SMOTE, predicted by a logistic regression model;

FIG. 43B illustrates a confusion matrix representing a binary classification of being unacceptable and being acceptable for Protein B protein incorporated into pound cake in the balanced validation dataset after SMOTE, predicted by a logistic regression model;

FIG. 44A illustrates a confusion matrix representing a multi-class classification of being unacceptable, being acceptable and being great for Protein B protein incorporated into pound cake in the balanced validation dataset after SMOTE, predicted by a support vector classifier (SVC) model;

FIG. 44B illustrates a confusion matrix representing a binary classification of being unacceptable and being acceptable for Protein B protein incorporated into pound cake in the balanced validation dataset after SMOTE, predicted by an SVC model;

FIG. 45A illustrates a confusion matrix representing a multi-class classification of being unacceptable, being acceptable and being great for Protein B protein incorporated into pound cake in the balanced validation dataset after SMOTE, predicted by a k-NN model;

FIG. 45B illustrates a confusion matrix representing a binary classification of being unacceptable and being acceptable for Protein B protein incorporated into pound cake in the balanced validation dataset after SMOTE, predicted by a k-NN model;

FIG. 46A illustrates a confusion matrix representing a multi-class classification of being unacceptable, being acceptable and being great for Protein B protein incorporated into pound cake in the balanced validation dataset after SMOTE, predicted by a decision tree model;

FIG. 46B illustrates a confusion matrix representing a binary classification of being unacceptable and being acceptable for Protein B protein incorporated into pound cake in the balanced validation dataset after SMOTE, predicted by a decision tree model;

FIG. 47A illustrates a confusion matrix representing a multi-class classification of being unacceptable, being acceptable and being great for Protein B protein incorporated into pound cake in the balanced validation dataset after SMOTE, predicted by a random forest model;

FIG. 47B illustrates a confusion matrix representing a binary classification of being unacceptable and being acceptable for Protein B protein incorporated into pound cake in the balanced validation dataset after SMOTE, predicted by a random forest model;

FIG. 48A illustrates a confusion matrix representing a multi-class classification of being unacceptable, being acceptable and being great for Protein B protein incorporated into pound cake in the balanced validation dataset after SMOTE, predicted by an AdaBoost model;

FIG. 48B illustrates a confusion matrix representing a binary classification of being unacceptable and being acceptable for Protein B protein incorporated into pound cake in the balanced validation dataset after SMOTE, predicted by an AdaBoost model;

FIG. 49A lists the accuracy for binary and multi-class classification of Protein B protein incorporated into pound cake with balanced sensory dataset after SMOTE using various machine learning models;

FIG. 49B illustrates the performance of AdaBoost regression to predict pound cake height from functional assays that were performed on one or more products.

FIG. 50 compares the training accuracy and validation accuracy for predicting performance of Protein B protein incorporated into various applications using FTIR data for machine learning models to predict and additionally TPA features, respectively; and

FIG. 51 illustrates the application of distance analysis to evaluate application quality at a downstream process step;

FIG. 52 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Disclosed is a system and method for using machine learning to predict the performance of a synthetic product (e.g., an egg protein) in various food and beverage-related applications. The synthetic product may, for example, be incorporated in applications in which egg proteins (e.g., from egg whites or egg yolks) are normally used. These applications may be, for example, baking into a pound cake, use as a burger binding, scrambling, incorporation into a protein bar (e.g., a date bar) or beverage in powder form.

To generate ground truth data, a panel of experts may sample (e.g., taste) food or beverage products incorporating the synthetic product. They may then provide a score associated with performance of the synthetic product. The score may reflect, for example, the taste, smell, texture, or look of the food or beverage comprising the product, when compared to a food or beverage containing the naturally-occurring product. The panel of experts may provide a binary determination of quality (e.g., 0 for bad or 1 for good), or a multiclass determination (e.g., 0 for bad, 1 for acceptable, or 2 for great).

The performance or quality of the synthetic product may reflect a similarity to the naturally-occurring product. For example, if the synthetic product closely approximates the taste, smell, odor, mouth feel, texture, or other characteristics of the naturally-occurring product, the synthetic product may closely approximate the naturally-occurring product in composition (e.g., chemical composition). The synthetic product may thus be similar nutritionally (e.g., comprising similar amounts of proteins, lipids (e.g., fat and/or cholesterol), carbohydrates (e.g., sugars and/or starches), vitamins (e.g., vitamin A, vitamin B, vitamin C, and/or vitamin D), or minerals (e.g., iron, niacin, magnesium, calcium, sodium, and/or potassium). The synthetic product may also comprise similar amounts or proportions of other compounds or substances (e.g., ash).

The performance or quality of the synthetic product may reflect a similarity of an effect produced by the synthetic product on a human subject to that of the corresponding naturally-occurring product. Effects may include nutritional content, similar or improved functionality in applications to the natural products (ie. a direct replacement). Effects may include similar or improved taste in application by making use of hedonic scores and sensory panels. Effects may be health-promoting, including relief from health conditions (e.g., hunger, dehydration, constipation, headaches, body aches, nausea, feeling faint, lightheadedness, fever, congestion, or fatigue).

The system may predict the performance of the synthetic product by performing machine learning analysis of Fourier transform infrared (FTIR) data produced from a biological sample. The biological sample may comprise, for example, one or more recombinant cells (e.g., from one or more microorganisms) expressing the synthetic product. FTIR spectroscopy may produce a visual plot (e.g., comprising peaks and troughs associated with absorption of electromagnetic radiation of different wavelengths) that may be processed by one or more machine learning models.

The machine learning models may comprise binary or multiclass classifiers. For example, the machine learning models may comprise neural networks (e.g., convolutional neural networks (CNNs), or recurrent neural networks (RNNs)), support vector classifiers, k-nearest neighbors (k-NN), decision trees (e.g., random forest or AdaBoost), or another type of classifier. In some embodiments, regression methods may include elastic net regression, support vector regression (SVR), random forest regression, and/or generative additive models (GAM s), AdaBoost with regression trees, partial least squares (PLS), and principal components regression (PCR), or a neural network.

The machine learning models may be trained to make a prediction as to the quality of performance of the synthetic product. For example, a binary classifier may output a 0 for a poor-quality product or a 1 for a superior quality product. A multiclass classifier may likewise output a 0, 1, or 2 for a poor, fair, or good-quality product, respectively.

An aspect of the present disclosure includes a method for predicting product performance or quality, comprising: (a) obtaining data associated with generation of one or more products, wherein the data comprises Fourier transform infrared (FTIR) data; and (b) processing the data using one or more machine learning models to generate a prediction of performance or quality of the one or more products when incorporated into one or more applications for consumption as food and/or beverage.

In some embodiments, the method further comprises training a machine learned model with a training dataset for predicting the performance of Protein A protein. In some embodiments, after the machine learned model is trained, the method comprises applying the trained machine learned model to generate a prediction of performance of quality of the one or more products.

In some embodiments, the one or more applications comprise a plurality of different applications for Protein A.

In some embodiments, the one or more products comprise at least one product in powder form.

In some embodiments, the one or more applications comprise at least one food application or food type.

In some embodiments, the one or more products is used as a binder in the at least one food application or food type.

In some embodiments, the at least one food application or food type comprise a food bar, broth, chocolate, meringue, pound cake, scramble, or burger binding.

In some embodiments, the one or more applications comprise at least one beverage application or beverage type.

In some embodiments, the one or more products is used as a neutral protein in the at least one beverage application or beverage type.

In some embodiments, the at least one beverage application or beverage type comprises coffee, tea, coconut water, non-dairy milk, or juice.

In some embodiments, the prediction of performance or quality comprises one or more scores associated with one or more attributes for the one or more applications.

In some embodiments, the one or more attributes comprise sensory attributes associated with sensory perception of the one or more applications.

In some embodiments, the sensory attributes comprise flavor, texture, mouth feel, taste, odor or appearance.

In some embodiments, the one or more attributes comprise functionality attributes associated with the incorporation of the one or more products into the one or more applications.

In some embodiments, the functionality attributes relate to cooking functionality including gelation, foaming, scramble, baking, cooking experience, or appearance of food or beverage applications during preparation.

In some embodiments, the one or more scores are predictive of a level of acceptance, acceptability or satisfaction to a group of consumers of the one or more applications for consumption as food and/or beverage.

In some embodiments, the prediction of performance or quality is generated independent of, without using, or prior to use of a human sensory panel.

In some embodiments, the FTIR data comprises FTIR spectra of at least one powdered product.

In some embodiments, the FTIR data comprises FTIR spectra of at least one aqueous product.

In some embodiments, the FTIR data comprises FTIR spectra of at least one product comprising a powder and aqueous mixture.

In some embodiments, the data further comprises rheological data.

In some embodiments, the data further comprises strong cation exchange (SCX) chromatography data.

In some embodiments, the one or more machine learning models are generated based at least in a part on a plurality of features, an importance level or weight of each feature, and interactions between different features (causal inference or relationships).

In some embodiments, the plurality of features comprise at least two of the following: FTIR spectrum, DSP quality, USP quality, flavor, powder quality, or functional assays applied to the one or more products.

In some embodiments, the one or more machine learning models comprise one or more classification models.

In some embodiments, the one or more machine learning models comprise AdaBoost, K-nearest neighbor, random forest, decision tree, support vector, or a neural network.

In some embodiments, the one or more machine learning models comprise at least one model that is trained using in part sensory data.

In some embodiments, the one or more machine learning models comprise at least one model that is not trained using any sensory data.

In some embodiments, the FTIR data is un-augmented.

In some embodiments, the FTIR data is augmented with synthetically generated data comprising of simulated FTIR spectra and/or simulated noise.

In some embodiments, the synthetically generated data is generated using a sampling algorithm.

In some embodiments, the sampling algorithm comprises Synthetic Minority Over-sampling Technique (SMOTE).

### Sample

Embodiments of the disclosure may perform FTIR on a biological sample. The sample may comprise one or more proteins.

In some embodiments, the proteins are expressed in a cell. In some embodiments, the cell is a recombinant cell. In some embodiments, the recombinant cell is a microbial cell.

The microbial cells may be from organisms from a Komagataella species, a Saccharomyces species, a Trichoderma species, a Pseudomonas species, an Aspergillus species, or an E. coli species.

In some cases, the recombinant cell may be a methanotroph. Among methanotrophs, Komagataella pastoris and Komagataella phaffii are preferable (also known as Pichia pastoris). Examples of strains in the Komagataella genus include Pichia pastoris strains. Examples can include NRRL Y-11430, BG08, BG10, NRRL Y-11430 GS115 (NRRL Y-15851), GS190 (NRRL Y-18014), PPF1 (NRRL Y 18017), PPY 1200H, YGC4, and strains derived therefrom. Other examples of P. pastoris strains that may be used as host cells include but are not limited to CBS7435 (NRRL Y-11430), CBS704 (DSM Z 70382) or derivatives thereof. Other examples of methanol-utilizing yeast include yeasts belonging to Ogataea (Ogataea polymorpha), Candida (Candida boidinii), Torulopsis (Torulopsis) or Komagataella.

Further examples of suitable host cell organisms include but are not limited to eukaryotic cells such as: Arxula spp., Arxula adeninivorans, Kluyveromyces spp., Kluyveromyces lactis, Komagataella spp., Pichia angusta, Pichia pastoris, Saccharomyces spp., Saccharomyces cerevisiae, Schizosaccharomyces spp., Schizosaccharomyces pombe, Yarrowia spp., Yarrowia lipolytica, Agaricus spp., Agaricus bisporus, Aspergillus spp., Aspergillus awamori, Aspergillus fumigatus, Aspergillus nidulans, Aspergillus niger, Aspergillus oryzae, Colletotrichum spp., Colletotrichum gloeosporiodes, Endothia spp., Endothia parasitica, Fusarium spp., Fusarium graminearum, Fusarium solani, Mucor spp., Mucor miehei, Mucor pusillus, Myceliophthora spp., Myceliophthora thermophila, Neurospora spp., Neurospora crassa, Penicillium spp., Penicillium camemberti, Penicillium canescens, Penicillium chrysogenum, Penicillium (Talaromyces) emersonii, Penicillium funiculosum, Penicillium purpurogenum, Penicillium roqueforti, Pleurotus spp., Pleurotus ostreatus, Rhizomucor spp., Rhizomucor miehei, Rhizomucor pusillus, Rhizopus spp., Rhizopus arrhizus, Rhizopus oligosporus, Rhizopus oryzae, Trichoderma spp., Trichoderma altroviride, Trichoderma reesei, Trichoderma vireus, Aspergillus oryzae, Bacillus subtilis, Escherichia coli, Myceliophthora thermophila, Neurospora crassa, Pichia pastoris, Pichia Pastoris “MutS” strain (Graz University of Technology (CBS7435MutS) or Biogrammatics (BG11)), Komagatella phaffi, and Komagatella pastoris.

In some cases, a bacterial host cell such as Lactococcus lactis, Bacillus subtilis or Escherichia coli may be used as the host cells. Other host cells include bacterial hosts such as, but not limited to, Lactococci sp., Lactococcus lactis, Bacillus subtilis, Bacillus amyloliquefaciens, Bacillus licheniformis and Bacillus megaterium, Brevibacillus choshinensis, Mycobacterium smegmatis, Rhodococcus erythropolis and Corynebacterium glutamicum, Lactobacilli sp., Lactobacillus fermentum, Lactobacillus casei, Lactobacillus acidophilus, Lactobacillus plantarum, Pseudomonas sp., Pseudomonas fluorescens.

The proteins may be animal or animal egg proteins. The egg proteins may naturally be expressed by birds and/or reptiles including poultry, fowl, waterfowl, game bird, chicken, quail, turkey, turkey vulture, hummingbird, duck, ostrich, goose, gull, guineafowl, pheasant, emu, crocodile, owl, finch, pigeon, or penguin eggs.

The egg-proteins may be Protein Bovabumin (Protein B), ovomucoid (Protein A), ovotransferrin, lysozyme proteins, ovomucin, ovoglobulin G2, ovoglobulin G3, ovoinhibitor, ovoglycoprotein, flavoprotein, ovomacroglobulin, ovostatin, cystatin, avidin, Protein B ovalbumin related protein X, or Protein B ovalbumin related protein Y, or any combination thereof. In some embodiments, Protein B is ovalbumin.

### Fourier Transform Infrared Spectroscopy (FTIR)

Fourier transform infrared spectroscopy (FTIR) may determine the content of a biological sample (e.g., a sample comprising one or more proteins) by measuring the spectrum of light that the sample absorbs. FTIR may comprise using an instrument (e.g., a spectrometer) to shine a beam comprising many frequencies of light at once on the sample and measure how much of that beam is absorbed. This beam may be iteratively modified to contain different combinations of wavelengths of light. An instrument may measure the light absorption of the sample per wavelength of light by taking the Fourier transform of the raw measurement data to create an interferogram.

### System

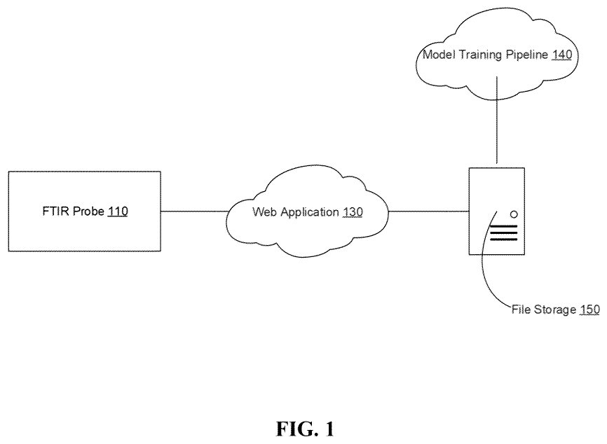

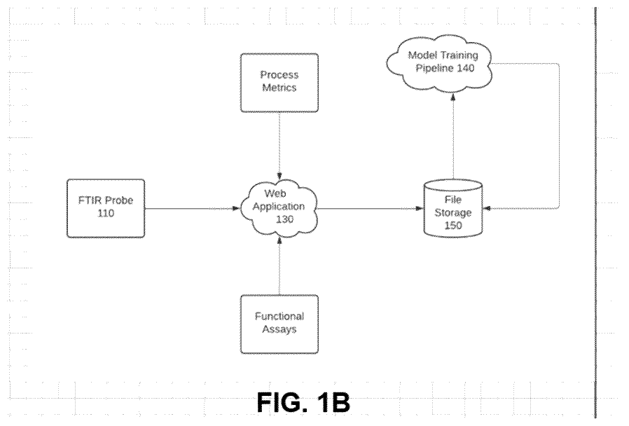

FIG. 1 illustrates a system for predicting product performance or quality from analysis of Fourier transform infrared spectroscopy (FTIR) data associated with generation of the product, in accordance with some embodiments.

The physical FTIR probe 110 (or instrument) may perform FTIR on sample data. The FTIR probe may comprise a light source, an interferometer, a sample compartment, a detector, amplifier, analog-to-digital (A/D) convertor, and/or a computer. The light source may generate radiation which is processed by the interferometer before interacting with the sample and then with the detector. The interferometer may be a Michelson interferometer. The interferometer may produce a signal which may be amplified by the amplifier and then converted into a digital signal by the A/D converter. The digital signal may then be transferred to a computer, where it may be processed by an interferogram.

The physical FTIR probe 110 may produce raw spectra files as output. The physical probe may be a spectrometer, such as a ReactIR® probe or a MATRIX-MF FT-IR® probe.

The web application 130 may enable a user of the system to, via a network, submit or upload data (e.g., FTIR spectra) and/or metadata for computer processing (e.g., processing by one or more machine learning models). For example, the web application 130 may provide metadata to storage and raw spectra to a file storage database. The web application 130 may be a browser-based application or a software application that may have access to a computer network (e.g., the Internet). The web application 130 may be accessible via one or more client devices. The client device may be a computing device, such as a desktop computer, laptop computer, smartphone, or tablet computer.

The model training pipeline 140 may be a computing unit that may facilitate training of one or more machine learning algorithms. Facilitating training may include providing data as inputs to a machine learning model, analyzing outputs of a machine learning model, and/or configuring a machine learning model's parameters and/or hyperparameters. The training pipeline may include one or more pre-processing systems to modify the data prior to training. The training system may control over how many epochs to train the model, a learning rate for a machine learning model, or what type of convergence condition to use (e.g., a loss function) to complete training of an ML model. The training system may be triggered by the upload of new spectra data to the web application 130 to enable “continuous” learning. The training pipeline may post all data set modeling metrics such as accuracy and F1-Score for classification models and mean squared error or median absolute error for regression models. The training system may be configured to transmit containerized models through a designated pipeline to a cloud-based storage repository, wherein the latest model is automatically deployed to the web application 130 upon completion of the deployment process.

File storage 150 may comprise one or more databases. A database may be one or more memory devices configured to store data. Additionally, the databases may also, in some embodiments, be implemented as a computer system with a storage device. In one aspect, the databases (e.g., local databases and cloud databases) may be used by components of the fermentation monitoring system to perform one or more operations consistent with the disclosed embodiments.

A database may store raw data (i.e., spectra data), data about a predictive model (e.g., parameters, hyperparameters, model architecture, threshold, rules, etc.), or data generated by a predictive model (e.g., intermediary results, output of a model, latent features, input, and/or output of a component of a model).

Databases may comprise cloud databases and/or local databases. One or more cloud databases and local databases of the platform may utilize any suitable database techniques. For instance, a structured query language (SQL) or “NoSQL” database may be utilized for storing data, including raw spectral data, metadata, and trained or untrained ML models or algorithms. Some of the databases may be implemented using various standard data-structures, such as an array, hash, (linked) list, struct, structured text file (e.g., XML), table, JavaScript Object Notation (JSON), NoSQL and/or the like. Such data-structures may be stored in memory and/or in (structured) files.

In another alternative, an object-oriented database may be used. Object databases can include several object collections that are grouped and/or linked together by common attributes; they may be related to other object collections by some common attributes. Object-oriented databases perform similarly to relational databases with the exception that objects are not just pieces of data but may have other types of functionalities encapsulated within a given object.

In some embodiments, the database may include a graph database that uses graph structures for semantic queries with nodes, edges and properties to represent and store data. If the database is implemented as a data-structure, the use of the database may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

FTIR spectroscopy data, machine learning models, and products of machine learning analysis (e.g., predictions) may be communicated via a network architecture. In some embodiments, the network architecture may comprise a local network. The local network may be a mesh network where devices communication with each other without a centralized device, such as a hub, switch, or router. In some embodiments, the network may be a local area network (LAN), a wide area network (WAN), a Wi-Fi network, a cellular network, or another network.

FIG. 2 is a process 200 for predicting product performance or quality from analysis of FTIR data associated with generation of the product.

The FTIR data may comprise FTIR spectra of at least one powdered product. The FTIR data may comprise FTIR spectra of at least one aqueous product. The FTIR data may comprise FTIR spectra of at least one product comprising a powder and aqueous mixture. The FTIR data may be un-augmented. The FTIR data may be augmented with synthetically generated data comprising of simulated FTIR spectra and/or simulated noise. The synthetically generated data may be generated using a sampling algorithm. The sampling algorithm may comprise Synthetic Minority Over-sampling Technique (SMOTE).

In a first operation 210, the system may obtain data associated with generation of one or more products. Data associated with the generation of the one or more products may comprise the FTIR data. The data may comprise rheological data. The data may further comprise strong cation exchange (SCX) chromatography data. The one or more products may comprise at least one product in powder form.

In a second operation 220, the system may process the data using one or more machine learning models to generate a prediction of performance or quality of the products. In some embodiments, the products are incorporated into applications for consumption as food and/or beverage.

The one or more machine learning models may be generated based at least in a part on a plurality of features, an importance level or weight of each feature, and interactions between different features (causal inference or relationships). The plurality of features may comprise at least two of the following: FTIR spectrum, DSP quality, USP quality, flavor, or powder quality.

The machine learning models may comprise one or more classification models. The one or more machine learning models may comprise AdaBoost, K-nearest neighbor, random forest, decision tree, support vector, or a neural network. The one or more machine learning models may comprise at least one model that is trained using in part sensory data. The one or more machine learning models may comprise at least one model that is not trained using any sensory data.

The prediction of performance or quality may comprise one or more scores associated with one or more attributes for the one or more applications. The one or more scores may be predictive of a level of acceptance, acceptability or satisfaction to a group of consumers of the one or more applications for consumption as food and/or beverage. The one or more attributes may comprise sensory attributes associated with sensory perception of the one or more applications. The sensory attributes may comprise flavor, texture, mouth feel, taste, odor or appearance. The one or more attributes may comprise functionality attributes associated with the incorporation of the one or more products into the one or more applications. The functionality attributes may relate to cooking functionality including gelation, foaming, scramble, baking, cooking experience, or appearance of food or beverage applications during preparation. The prediction of performance or quality may be generated independent of, without using, or prior to use of a human sensory panel.

Additional attributes may comprise hardness, cohesiveness, chewiness, foam capacity, or foam stability.

Attributes may relate to an overall similarity of the food products to a control food product. A control sample may comprise a naturally occurring product. Non-limiting examples of naturally occurring product may comprise a whole hen's egg, egg white, egg yolk etc. In some embodiments, the control sample can be seasoned. Alternatively, the control sample can be unseasoned. As described herein, “similarity” of food products generally refers to how similar or different a subject (e.g., a human rater) feels of the food product when compared to a control food product. Feedback data of similarity may comprise a binary format, e.g., same and not same (or different). Levels or degrees of similarity may comprise very largely similar, largely similar, moderately largely similar, moderately similar, slight moderately similar, very slightly similar, not similar (different), very slightly different, slightly different, slight moderately different, moderately different, moderately largely different, and very largely different.

Attributes may relate to an overall likeability of the food products. Likeability generally refers to how a human rater likes the food product. Likeability may vary from human rater to human rater. An assessment of likeability may comprise a binary format, e.g., like and dislike. Feedback data of likeability may comprise structured data or unstructured data corresponding to a plurality of levels or degrees of likeability, for example, from dislike extremely to like extremely. Levels or degrees of likeability may comprise dislike extremely, dislike very much, dislike moderately, dislike slightly, neither like nor dislike, like slightly, like moderately, like very much and like extremely.

The attributes may comprise cooking functionality. Non-limiting examples of cooking functionalities may include gelation, foaming, gelatinization, or baking.

The applications for consumption as food and/or beverage comprise at least one application for ovomucoid (Protein A). The one or more applications may comprise at least one food application or one food type. The one or more products may be used as a binder in the at least one food application or food type. The at least one food application or food type may comprise a food bar, broth, chocolate, meringue, pound cake, a scramble, or a burger binding. The one or more applications may comprise at least one beverage application or beverage type. The one or more products may be used as a neutral protein in the at least one beverage application or beverage type. The at least one beverage application or beverage type may comprise coffee, tea, coconut water, non-dairy milk, or juice.

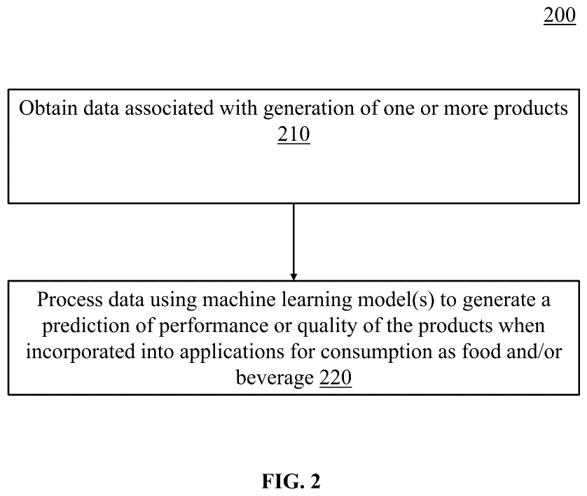

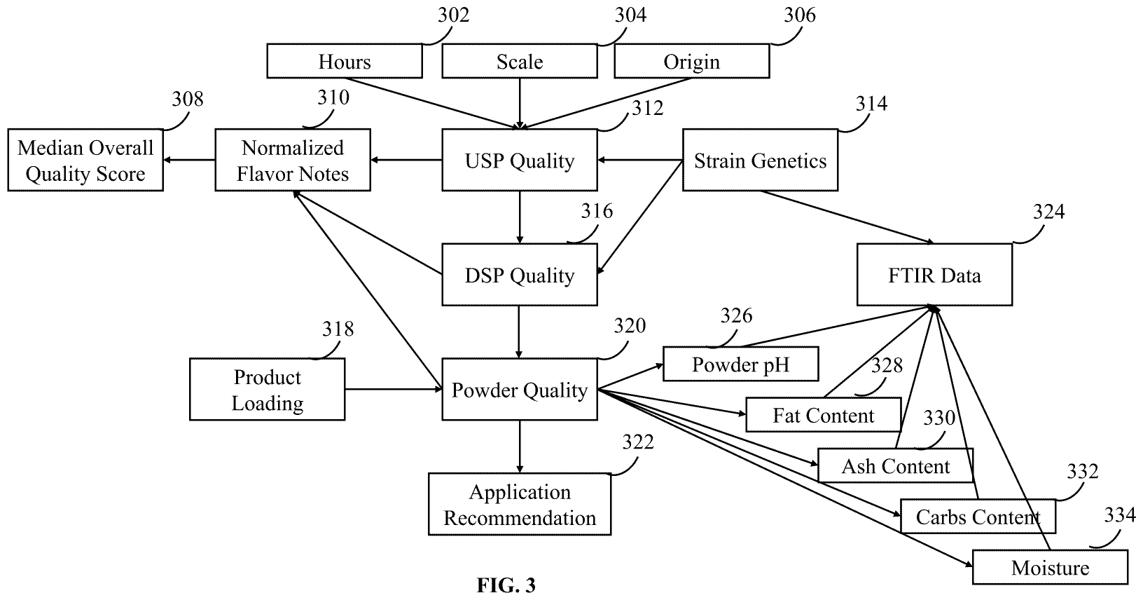

FIG. 3 illustrates a product graph 300. The product graph 300 may provide a representation of relationships between measured and derived quantities which relate to performance of synthetic proteins in various food-based applications. The measured and derived quantities shown in the product graph 300 may be non-exhaustive, and may only be a subset of all of the determinants of application effectiveness.

For example, hours 302 (e.g., fermentation time), scale 304 (e.g., size of the fermentation tank), origin 306 (e.g., manufacturing site, location where the fermentation takes place), and strain genetics 314 may directly influence upstream processing (USP, e.g., initial tasks in the fermentation process) quality 312. Strain genetics 314 may also impact downstream processing (DSP, e.g., the recovery and purification of biological products from natural sources) quality 316, which itself may have a direct effect on powder quality 320. Powder quality may also be affected by product loading 318 (e.g., inclusion percentage, the amount of protein included in a product). Powder quality 320 may relate to the extent to which synthetic product satisfies certain conditions and performs similarly to a naturally occurring product in a certain application. For example, the powder quality 320 may affect the powder pH 326, fat content 328, ash content 330, carbohydrate content 332, and/or moisture 334. These factors in turn may influence the FTIR data 324 of a sample, along with strain genetics 314. Thus, FTIR data 324 may inform whether to recommend a synthetic product for a particular application. USP quality 312, DSP quality 316, and powder quality 320 may also impact normalized flavor notes 310, which may directly impact the median overall quality score 308. Powder quality may impact expert derived ratings of flavors for individual attributes, so normalized flavor notes refer to the difference in a hidden control and a sample per user that is averaged across users. These factors may be used to determine an overall mean quality score 308 which represents how closely synthetic product resembles a naturally occurring product when used in a certain application.

### Machine Learning

a. Training Phase

A machine learning software module may be provided by a server and may implement one or more machine learning algorithms. A machine learning software module as described herein is configured to undergo at least one training phase wherein the machine learning software module is trained to carry out one or more tasks including data extraction, data analysis, and generation of output.

In some embodiments of the software application described herein, the software application comprises a training module that trains the machine learning software module. The training module is configured to provide training data to the machine learning software module, the training data comprising, for example, Fourier transform infrared spectroscopy (FTIR) data and ground truth data comprising evaluations of performance or quality. In some embodiments of a machine learning software module described herein, a machine learning software module utilizes automatic statistical analysis of data to determine which features to extract and/or analyze from FTIR data. In some of these embodiments, the machine learning software module determines which features to extract and/or analyze from subject health data based on the training that the machine learning software module receives.

In some embodiments, a machine learning software module is trained using a data set and a target in a manner that might be described as supervised learning. In these embodiments, the data set is conventionally divided into a training set, a test set, and, in some cases, a validation set. In some embodiments, the data set is divided into a training set and a validation set. A target is specified that contains the correct classification of each input value in the data set. For example, a set of FTIR data is repeatedly presented to the machine learning software module, and for each sample presented during training, the output generated by the machine learning software module is compared with the desired target. The difference between the target and the set of input samples is calculated, and the machine learning software module is modified to cause the output to more closely approximate the desired target value. In some embodiments, a back-propagation algorithm is utilized to cause the output to more closely approximate the desired target value. After many training iterations, the machine learning software module output will closely match the desired target for each sample in the input training set. Subsequently, when new input data, not used during training, is presented to the machine learning software module, it may generate an output classification value indicating which of the categories the new sample is most likely to fall into. The machine learning software module is said to be able to “generalize” from its training to new, previously unseen input samples. This feature of a machine learning software module allows it to be used to classify almost any input data which has a mathematically formulatable relationship to the category to which it should be assigned.

In some embodiments of the machine training software module described herein, the machine training software module utilizes a simulated training model. A simulated training model is based on the machine training software module having trained at least in part on simulated FTIR data.

In some embodiments, the use of training models changes as the availability of FTIR data changes. For instance, a simulated training model may be used if there are insufficient quantities of FTIR data available for training the machine training software module to a desired accuracy. As additional data becomes available, the training model can change to a global or individual model. In some embodiments, a mixture of training models may be used to train the machine training software module. For example, a simulated and global training model may be used, utilizing a mixture of laboratory-obtained FTIR data and simulated data to meet training data requirements.

Unsupervised learning is used, in some embodiments, to train a machine training software module to use input data such as, for example, FTIR data and output, for example, a prediction of application performance or quality. Unsupervised learning, in some embodiments, includes feature extraction which is performed by the machine learning software module on the input data. Extracted features may be used for visualization, for classification, for subsequent supervised training, and more generally for representing the input for subsequent storage or analysis. In some cases, each training case may consist of a plurality of FTIR data.

Machine learning software modules that are commonly used for unsupervised training include k-means clustering, mixtures of multinomial distributions, affinity propagation, discrete factor analysis, hidden Markov models, Boltzmann machines, restricted Boltzmann machines, autoencoders, convolutional autoencoders, recurrent neural network autoencoders, and long short-term memory autoencoders. While there are many unsupervised learning models, they all have in common that, for training, they require a training set consisting of biological sequences, without associated labels.

A machine learning software module may include a training phase and a prediction phase. The training phase is typically provided with data to train the machine learning algorithm. Non-limiting examples of types of data inputted into a machine learning software module for the purposes of training include encoded data, encoded features, or metrics derived from FITR data. Data that is inputted into the machine learning software module is used, in some embodiments, to construct a hypothesis function to determine a predicted application performance or quality. In some embodiments, a machine learning software module is configured to determine if the outcome of the hypothesis function was achieved and based on that analysis determine with respect to the data upon which the hypothesis function was constructed. That is, the outcome tends to either reinforce the hypothesis function with respect to the data upon which the hypothesis function was constructed or contradict the hypothesis function with respect to the data upon which the hypothesis function was constructed. In these embodiments, depending on how close the outcome tends to be to an outcome determined by the hypothesis function, the machine learning algorithm will either adopt, adjust, or abandon the hypothesis function with respect to the data upon which the hypothesis function was constructed. As such, the machine learning algorithm described herein dynamically learns through the training phase what characteristics of an input (e.g., data) are most predictive in determining whether the features of FTIR data are associated with a particular application performance or quality.

For example, a machine learning software module is provided with data on which to train so that it, for example, can determine the most salient features of a received FTIR data to operate on. The machine learning software modules described herein train as to how to analyze the FTIR data, rather than analyzing the FTIR data using pre-defined instructions. As such, the machine learning software modules described herein dynamically learn through training what characteristics of an input signal are most predictive in determining whether the features of FTIR data predict a particular application performance or quality score.

In some embodiments, training begins when the machine learning software module is given FTIR data and asked to predict application performance or quality. The predicted application performance or quality is then compared to the true application performance or quality (e.g., as evaluated by an expert) that corresponds to the FTIR data. An optimization technique such as gradient descent and backpropagation is used to update the weights in each layer of the machine learning software module to produce closer agreement between the application performance or quality predicted by the machine learning software module, and the actual application performance or quality. This process is repeated with new FTIR data and application performance or quality data until the accuracy of the network has reached the desired level. An optimization technique is used to update the weights in each layer of the machine learning software module to produce closer agreement between the application performance or quality predicted by the machine learning software module, and the true application performance or quality. This process is repeated with new FTIR data and application performance or quality data until the accuracy of the network has reached the desired level.

In some embodiments, a strategy for the collection of training data is provided to ensure that the FTIR data represents a wide range of conditions to provide a broad training data set for the machine learning software module. For example, a prescribed number of measurements during a set period may be required as a section of a training data set. Additionally, these measurements can be prescribed as having a set amount of time between measurements.

In general, a machine learning algorithm is trained using FTIR data and/or any features or metrics computed from the above said data with the corresponding ground-truth values. The training phase constructs a transformation function for predicting an application performance or quality from FTIR data and/or any features or metrics derived from metadata. The machine learning algorithm dynamically learns through training what characteristics of input data are most predictive in determining application performance or quality. A prediction phase uses the constructed and optimized transformation function from the training phase to predict the application performance or quality by using the FTIR data and/or any features or metrics computed from or derived from metadata.

b. Prediction Phase

Following training, the machine learning algorithm is used to determine, for example, the application performance or quality on which the system was trained using the prediction phase. With appropriate training data, the system can identify an application's performance or quality.

The prediction phase uses the constructed and optimized hypothesis function from the training phase to predict an application performance or quality from the FTIR data.

In some embodiments, a probability threshold can be used in conjunction with a final probability to determine whether an application performance or quality matches the trained application performance or quality. In some embodiments, the probability threshold is used to tune the sensitivity of the trained network. For example, the probability threshold can be 1%, 2%, 5%, 10%, 15%, 20%, 25%, 30%, 35%, 40%, 45%, 50%, 55%, 60%, 65%, 70%, 75%, 80%, 85%, 90%, 95%, 98% or 99%. In some embodiments, the probability threshold is adjusted if the accuracy, sensitivity or specificity falls below a predefined adjustment threshold. In some embodiments, the adjustment threshold is used to determine the parameters of the training period. For example, if the accuracy of the probability threshold falls below the adjustment threshold, the system can extend the training period and/or require additional FTIR data and/or application quality measures. In some embodiments, additional measurements can be included into the training data. In some embodiments, additional measurements can be used to refine the training data set.

### Machine Learning Algorithms

Some embodiments described herein utilize machine learning to monitor and/or improve a fermentation process and/or another process to generate proteins through expression in a recombinant cell or organism. As the skilled artisan will readily appreciate, a number of different machine learning algorithms or models (including without limitation Bayes, M arkov, Gaussian processes, clustering algorithms, generative models, kernel and neural network algorithms) may be used without exceeding the scope described herein. As appreciated by the skilled artisan, typical neural networks employ, by way of example not limitation, one or more layers of nonlinear activation functions to predict an output for a received input and may include one or more hidden layers in addition to the input and output layers. The output of each hidden layer in some of these networks is used as input to the next layer in the network. Examples of neural networks include, by way of example and not limitation, generative neural networks, convolutional neural networks and recurrent neural networks.

### Decision Trees

The machine learning model may implement a decision tree. A decision tree may be a supervised machine learning algorithm that can be applied to both regression and classification problems. Decision trees may mimic the decision-making process of a human brain. For example, a decision tree may grow from a root (base condition), and when it meets a condition (internal node/feature), it may split into multiple branches. The end of the branch that does not split anymore may be an outcome (leaf). A decision tree can be generated using a training data set according to the following operations: (1) Starting from a root node (the entire dataset), the algorithm may split the dataset in two branches using a decision rule or branching criterion; (2) each of these two branches may generate a new child node; (3) for each new child node, the branching process may be repeated until the dataset cannot be split any further; (4) each branching criterion may be chosen to maximize information gain (e.g., a quantification of how much a branching criterion reduces a quantification of how mixed the labels are in the children nodes). The labels may be the data or the classification that is predicted by the decision tree.

### Random Forest

A random forest may be an extension of the decision tree model that tends to yield more robust predictions by stretching the use of the training data partition. Whereas a decision tree may make a single pass through the data, a random forest algorithm may bootstrap 50% of the data (e.g., with replacement) and build many trees. Rather than using all explanatory variables as candidates for splitting, a random subset of candidate variables may be used for splitting, which may enable trees that have completely different data and different variables (hence the term random). The predictions from the trees, collectively referred to as the “forest,” may be then averaged together to produce the final prediction. Many trees (e.g., one hundred trees) may be included in a random forest model, with a number (e.g., 3, 6, 10, etc.) of terms sampled per split, a minimum of number (e.g., 1, 2, 4, 10, etc.) of splits per tree, and a minimum split size (e.g., 16, 32, 64, 128, 256, etc.). Random forests may be trained in a similar way as decision trees. Specifically, training a random forest may include the following operations: (1) select randomly k features from the total number of features; (2) create a decision tree from these k features using the same operations as for generating a decision tree; and (3) repeat the previous two operations until a target number of trees is created.

### AdaBoost

AdaBoost is a machine learning algorithm which combines the outputs of other learning algorithms (“weak learners”) into a weighted sum, representing the final output of the algorithm. AdaBoost may be used for binary classification or multiclass classification tasks.

AdaBoost is an adaptive algorithm where, as new weak learners are added, they are modified in favor of instances misclassified by previous classifiers. Each weak learner may produce an output hypothesis which may fix a prediction for each sample in the training set. At each iteration, the algorithm may select a weak learner and assign the learner with a coefficient, such that the total training error of the classifier is minimized. Additionally at each iteration of the training process, a weight may be assigned to each sample in the training set equal to the current error on that sample. These weights may be used during the training process.

The learners may be decision tree algorithms. The system may tune the depth of the trees in the ensemble and the maximum number of estimators to use for the learning process (after this number has been reached, the process is terminated). AdaBoost may use shallow trees (e.g., with depths of 1, less than 5, less than 10, less than 15, or less than 20). The machine learning system may select a range (e.g., between 10 and 110) trees to use in the ensemble. An AdaBoost-based model may be trained on training and validation data to determine how well it may perform on never-encountered (“test”) data.

### Support Vector Classifier

Support vector machines (SVM) is an ML technique typically used to classify data. An SVM-based classifier may represent a data point as a p-dimensional vector and classify the data points by separating these vectors with a hyperplane. For a binary SVM classifier, a reasonable choice for hyperplane may represent a largest separation between two classes of data. This hyperplane may be found by maximizing the distance from the hyperplane to each of the nearest data points of the two classes. SVM s may also perform nonlinear classification using the kernel trick, implicitly mapping inputs into high-dimension feature spaces.

### Convolutional Neural Network

A trained convolutional neural network (CNN) (one example of a feed forward network), takes input data into convolutional layers (aka hidden layers), and applies a series of trained weights or filters to the input data in each of the convolutional layers. The output of the first convolutional layer is an activation map (not shown), which is the input to the second convolution layer, to which a trained weight or filter (not shown) is applied, where the output of the subsequent convolutional layers results in activation maps that represent more and more complex features of the input data to the first layer. After each convolutional layer a non-linear layer (not shown) is applied to introduce non-linearity into the problem, which nonlinear layers may include tan h, sigmoid or ReLU. In some cases, a pooling layer (not shown) may be applied after the nonlinear layers, also referred to as a downsampling layer, which basically takes a filter and stride of the same length and applies it to the input, and outputs the maximum number in every sub-region the filter convolves around. Other options for pooling are average pooling and L2-norm pooling. The pooling layer reduces the spatial dimension of the input volume reducing computational costs and to control overfitting. The final layer(s) of the network is a fully connected layer, which takes the output of the last convolutional layer and outputs an n-dimensional output vector representing the quantity to be predicted. The output could be a scalar value data point being predicted by the network, a stock price for example. Trained weights may be different for each of the convolutional layers, as will be described more fully below. To achieve this real-world prediction/detection (e.g., it's a boat), the neural network needs to be trained on known data inputs or training examples resulting in trained CNN. To train a CNN, many different training examples are input into the model.

The number of convolutional layers can be increased or decreased, as well as the number of fully-connected layers. In general, the optimal number and proportions of convolutional vs. fully-connected layers can be set experimentally, by determining which configuration gives the best performance on a given dataset. The number of convolutional layers could be decreased to 0, leaving a fully-connected network. The number of convolutional filters and width of each filter can also be increased or decreased.

The output of the neural network may be a single, scalar value, corresponding to an exact prediction for the primary time sequence. Alternatively, the output of the neural network could be a logistic regression, in which each category corresponds to a specific range or class of primary time sequence values, are any number of alternative outputs readily appreciated by the skilled artisan.

### K-Nearest Neighbors

K-Nearest Neighbors (k-NN) may classify an object or entity by placing it in a cluster defined by its “nearest neighbors.” The set of objects may be associated with corresponding representations (e.g., vectors) such that distances between any pair of objects may be calculated. For an object to be classified, the k-NN algorithm may generate a set of the k objects in the set that have the shortest distance to the object to be classified. These objects may already have been given classes (e.g., training may have been performed prior to using k-NN). If all objects of the set of k objects belong to the same class, the object to be classified may be placed into that class. If the objects of the set of k objects belong to different classes, the object to be classified may be placed in the class comprising the plurality of the set of k objects. For example, if k=10, and three of the objects in k are in Class 1, three of the objects in k are in Class 2, and four of the objects in k are in Class 3, the object to be classified may be placed in Class 3.

k-NN may be a type of classification where the function is only approximated locally and all computation is deferred until function evaluation. Since this algorithm relies on distance for classification, if the features represent different physical units or come in vastly different scales then normalizing the training data can improve its accuracy dramatically. a useful technique may be to assign weights to the contributions of the neighbors, so that the nearer neighbors contribute more to the average than the more distant ones. For example, a weighting scheme may comprise giving each neighbor a weight of 1/d, where d is the distance to the neighbor.

### Protein A—Containing Application Performance Prediction Using Machine Learning Models

The following examples describe the prediction of the performance of Protein A product incorporated into various applications using machine learning models. Protein A may be incorporated into different applications for consumption as food and beverage, where the applications include coffee, coconut water, non-dairy milk and protein bars. The machine learning models may process Fourier transform infrared (FTIR) data associated with generation of Protein A, and predict the performance or quality of Protein A when incorporated in these applications.

The following applications of food and beverage incorporated with Protein A protein are non-limiting examples that describe the present technology. Other example applications may include juice, fermented food/beverage, vegetable broth, plant-based food/beverage, chocolate or tea.

### Protein A—Containing Coffee Beverage Performance Prediction Using Machine Learning Models

FIG. 4 illustrates compositions of training dataset and validation dataset for predicting the performance of Protein A protein when incorporated into coffee beverage. The training dataset and validation data sets are coffee samples containing Protein A protein in a form of powder. The coffee samples, served hot or cold, are from two coffee companies and have different types, including original cold brew, expresso, black, and white. As illustrated, the training and validation data sets are labeled as “not recommended”, “good”, and “great”, determined by subject area experts.

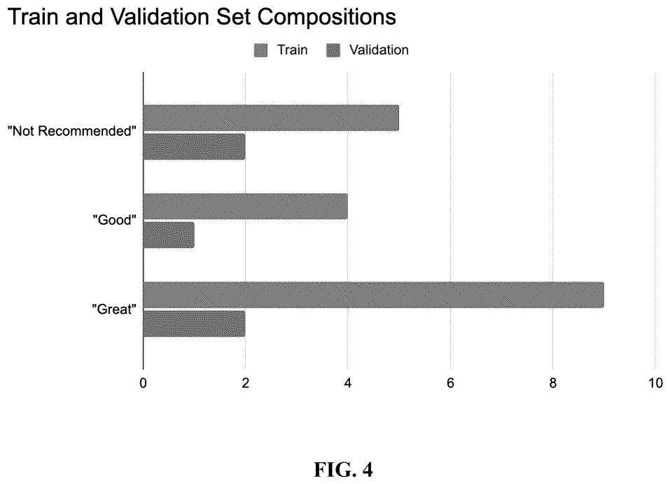

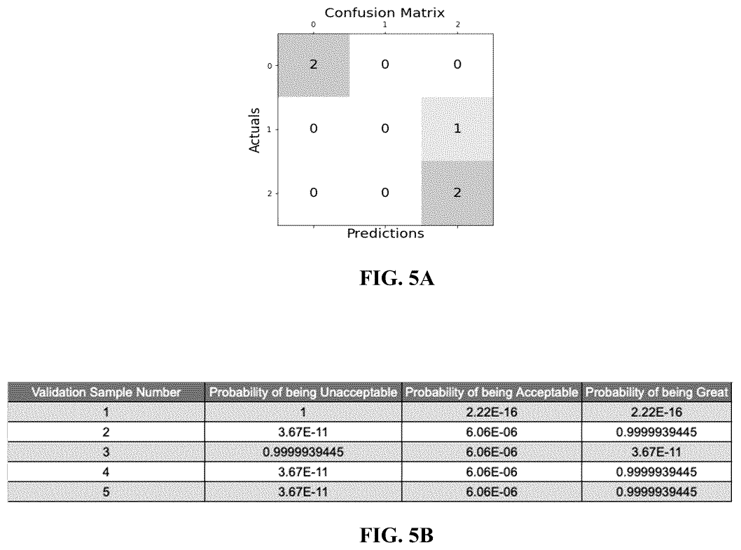

FIG. 5A illustrates a confusion matrix representing a multi-class classification of being unacceptable, being acceptable and being great for Protein A protein incorporated into coffee beverage in the validation dataset, predicted by AdaBoost model.

FIG. 5B lists a multi-class classification of being unacceptable, being acceptable and being great for Protein A protein incorporated into coffee beverages in the validation dataset, predicted by AdaBoost model. The model is learned to classify how the Protein A powder performs in various types of coffee beverages. As illustrated in FIG. 5A, for example, the predicted classifications of four validation samples are aligned with their respective ground truths. Only one sample shows some discrepancy between the ground truth classification (i.e., being acceptable) and predicted classification (i.e., being great). Nevertheless, due to a small number of training samples, the model can be overconfident about the prediction as illustrated in FIG. 5B.

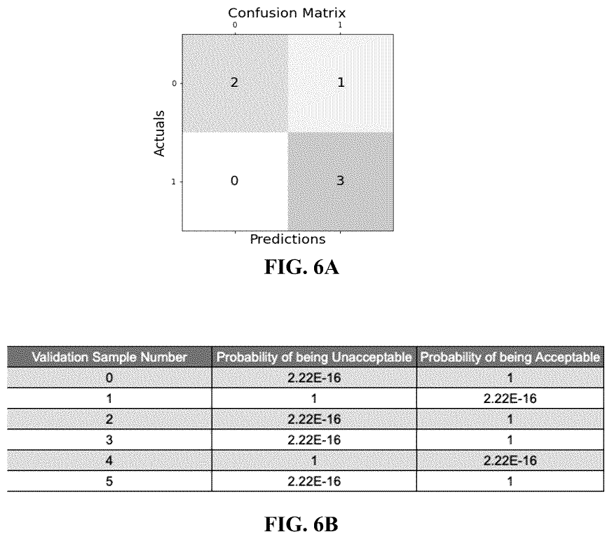

FIG. 6A illustrates a confusion matrix representing a binary classification of being unacceptable and being acceptable for Protein A protein incorporated into coffee beverages in the validation dataset, predicted by AdaBoost model. FIG. 6B lists the binary classification of being unacceptable and being acceptable for Protein A protein incorporated into coffee beverages in the validation dataset, predicted by AdaBoost model. As illustrated in FIG. 6A, the predicted classifications of five validation samples are aligned with their respective ground truth. Only one sample shows some discrepancy between the ground truth classification (i.e., being unacceptable) and predicted classification (i.e., being acceptable). Due to the small number of training samples, the change from multi-class classification to binary classification does not significantly improve the overconfidence of the model.

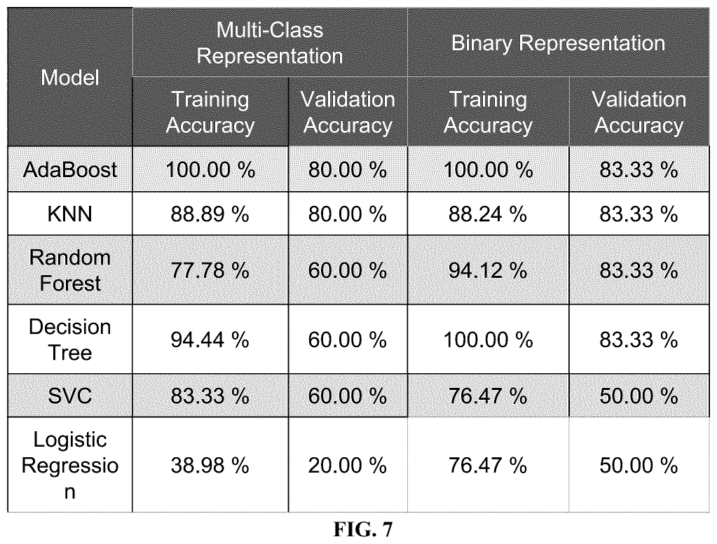

FIG. 7 lists the accuracy for binary and multi-class classification of quality for Protein A protein incorporated into coffee beverage using various machine learning models, including AdaBoost, k-nearest neighbors (k-NN), random forest, decision tree, support vector classifier (SVC) and logistic regression models. Each model performs binary classification (e.g., into “good” and “bad” categories) and multi-class (e.g., three-way, into “not recommended”, “good”, and “great” categories) classification using training dataset and validation dataset. Among others, AdaBoost model shows satisfactory training accuracy and validation accuracy in both binary and multi-class classifications. The k-NN model is less sensitive to small sample sizes, as the validation dataset has a much smaller sample size than the training dataset and the resulted accuracy is close to each other (88.89% v. 80.00% for multi-class classification; 88.24% v. 83.33% for binary classification.)

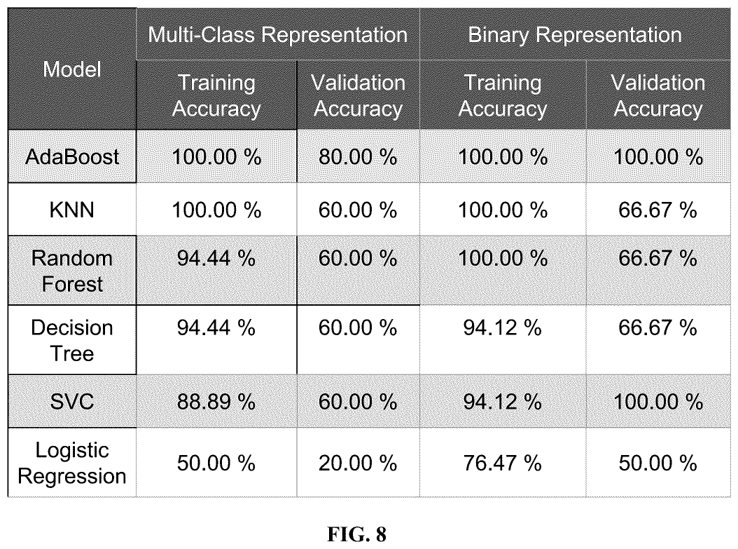

FIG. 8 lists the accuracy for binary and multi-class classification of Protein A protein incorporated into coffee beverage using various machine learning models when human sensory features are excluded. Human sensory features are obtained from in-house sensory panel. Compared to the accuracy results where human sensory features are included illustrated in FIG. 7, various models have a better application quality prediction performance. For example, the validation accuracy in binary classification using AdaBoost model is improved from 83.33% to 100%. Both the training and validation accuracies of binary classification using SVC show significant improvement when human sensory features are excluded. The training accuracy increased from 76.47% to 94.12%, and the validation accuracy from 50% to 100%.

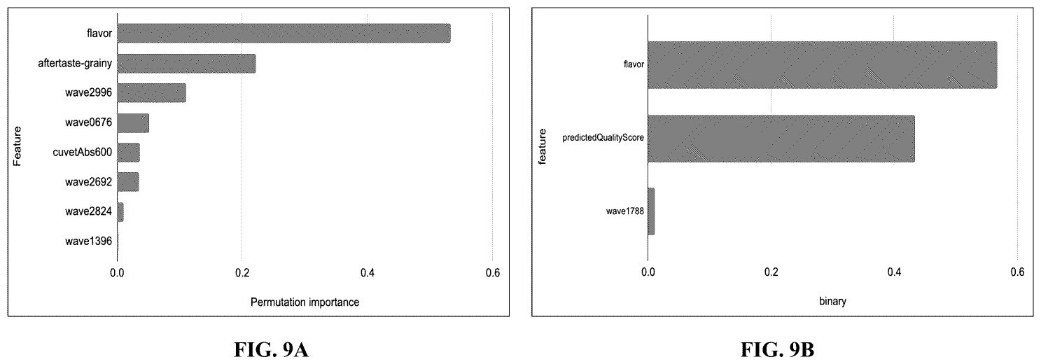

FIG. 9A illustrates feature importance for multi-class classification using AdaBoost model to predict the performance of Protein A protein incorporated into coffee beverages. Quality metrics of the coffee beverage including flavor, grainy aftertaste, and wavenumber absorbance at 1600 cm-1 from the FTIR data can be important features for the model to determine. As illustrated, FTIR data (e.g., wave2996, wave0676, wave2692, wave2824, wave1396) is important for predicting in-water overall likeability of the Protein A-containing coffee beverage.

FIG. 9B illustrates feature importance for binary classification using AdaBoost model to predict the performance of Protein A protein incorporated into coffee beverage. Compared to multi-class classification, binary classification requires fewer features, including flavor, predicted quality score and FTIR data (e.g., wave1788). Both figures demonstrate flavor and FTIR data are important variables in predicting the performance of Protein A protein incorporated in coffee beverage.

### Protein A—Containing Coconut Water Performance Prediction Using Machine Learning Models

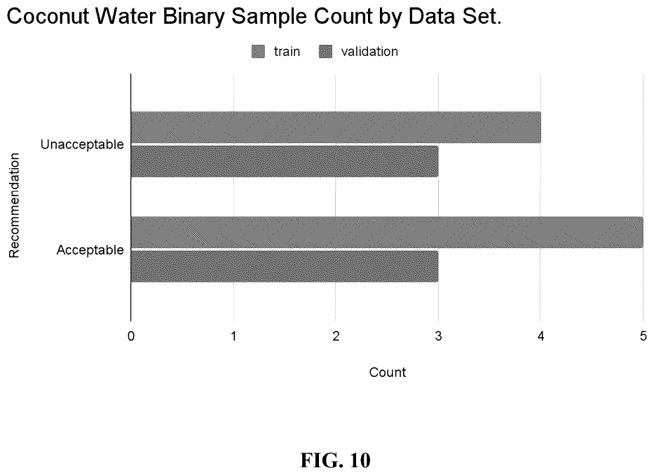

FIG. 10 illustrates compositions of a training dataset and a validation dataset for predicting the performance of Protein A protein when incorporated into coconut water. All training and validation datasets include different flavors of commercially available coconut water. Four lots of commercially available Protein A proteins are contained in the coconut water samples. As illustrated, the training and validation data sets are labeled as “unacceptable” and “acceptable”, determined by subject area experts on the Application Team.

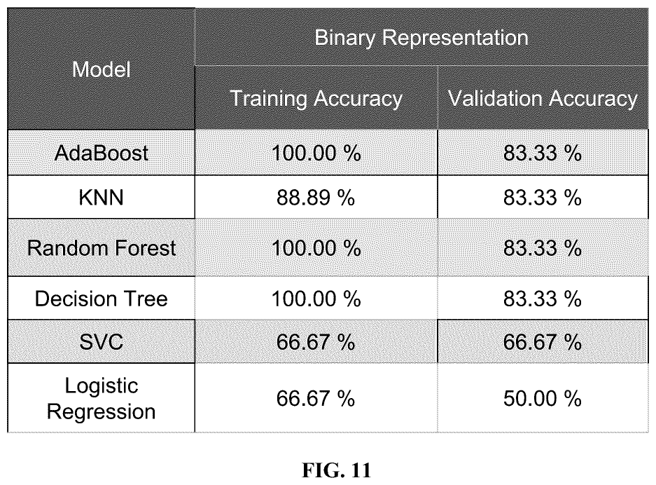

FIG. 11 lists the accuracy for binary classification of Protein A protein incorporated into coconut water using various machine learning models, including AdaBoost, k-NN, random forest, decision tree, support vector classifier (SVC) and logistic regression models. Each model performs binary classification using training dataset and validation dataset. Among others, AdaBoost, k-NN and random forest models show satisfactory training accuracy and validation accuracy in the classification. It is expected that the accuracy will further be improved using a larger number of training and validation datasets.

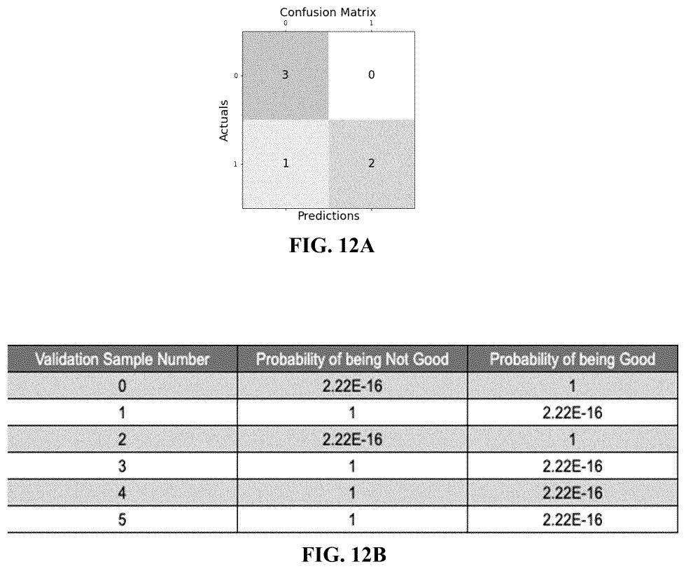

FIG. 12A illustrates a confusion matrix representing binary classification of being unacceptable and being acceptable/good for Protein A protein incorporated into coconut water in the validation dataset, predicted by an AdaBoost model. FIG. 12B illustrates a table quantifying the binary classification of being unacceptable and being acceptable/good for Protein A protein incorporated into coconut water in the validation dataset, predicted by AdaBoost model. As illustrated, the predicted classifications of five validation samples are aligned with their respective ground truth. Only one sample shows some discrepancy between the ground truth classification (i.e., being acceptable) and predicted classification (i.e., being unacceptable). Nevertheless, due to a small number of training samples, the model can be overconfident about the prediction as illustrated in FIG. 12B.

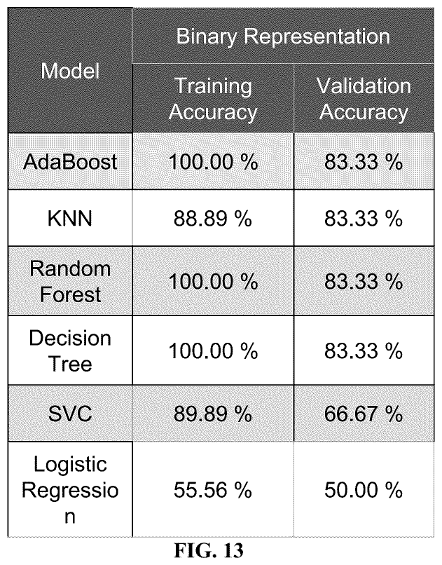

FIG. 13 lists the accuracy for the binary classification of being unacceptable and being acceptable/good for Protein A protein incorporated into coconut water using various machine learning models, when human sensory features are excluded. Compared to the accuracy results where human sensory features are included illustrated in FIG. 11, various models including AdaBoost, k-NN, random forest and decision tree maintain the same performance for both training and validation accuracies. The training accuracy for binary classification using SVC model is improved from 66.67% to 89.89%.

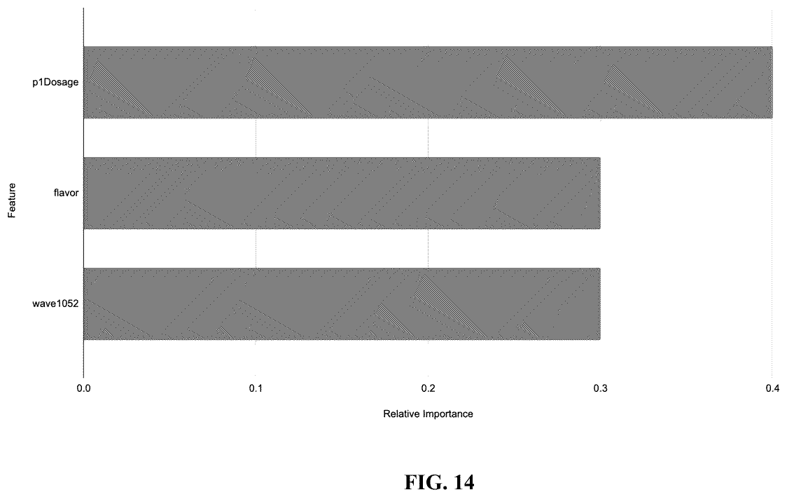

FIG. 14 illustrates feature importance for multi-class classification using AdaBoost model to predict the performance of Protein A protein incorporated into coconut water. Flavor and FTIR data (wave1052) are important variables for the prediction. Additionally, the amount of Protein A that is added to the coconut water (i.e., p1Dosage) impacts the sensory result and thus, is an important feature for the prediction.

### Protein A—Containing Non-Dairy Milk Performance Prediction Using Machine Learning Models

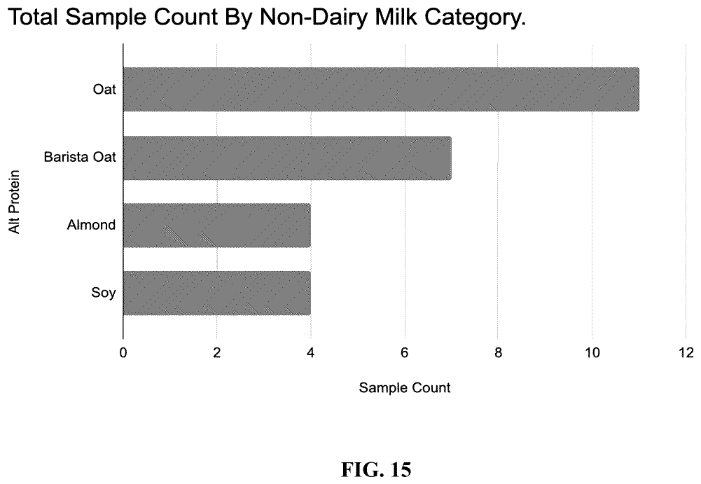

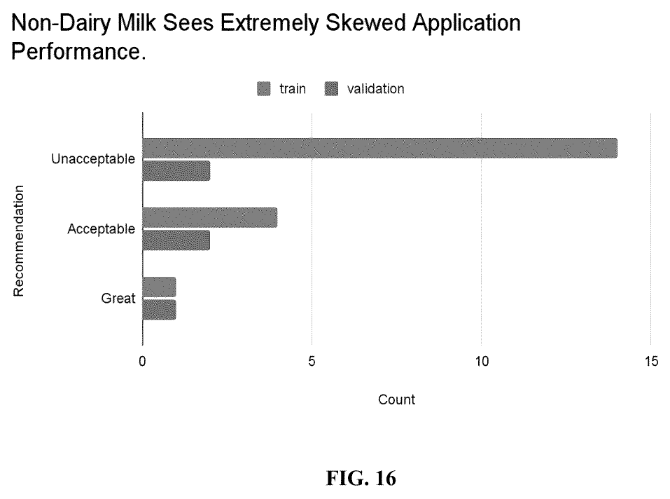

Non-dairy milk is another important application area where Protein A protein can be incorporated. Non-dairy milk covers a broad range of beverage classes. FIG. 15 illustrates total sample count by non-dairy milk category, including oat milk, barista oat milk, almond milk and soy milk. FIG. 16 illustrates compositions of training dataset and validation dataset for predicting the performance of Protein A protein when incorporated into non-dairy milk.

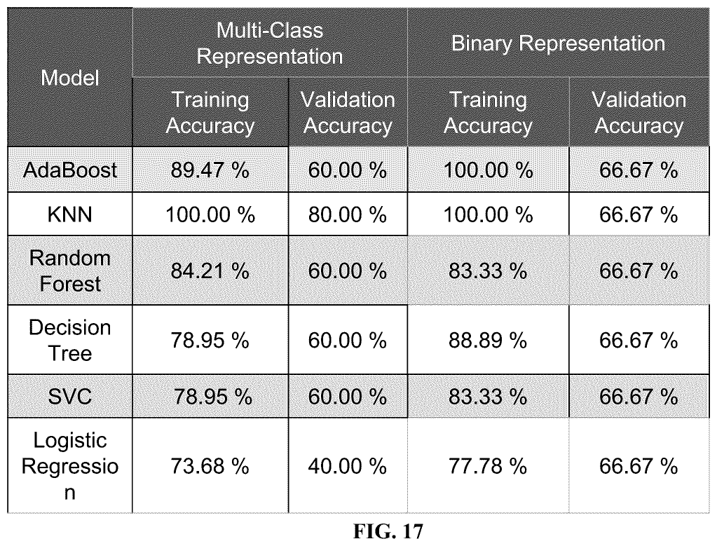

FIG. 17 lists the accuracy for binary and multi-class classification of Protein A protein incorporated into non-dairy milk using various machine learning models, including AdaBoost, k-NN, random forest, decision tree, SVC and logistic regression models. Each model performs binary classification and multi-class (e.g., three-way) classification using training dataset and validation dataset. Among others, k-NN model shows satisfactory accuracy using both training and validation datasets, for multi-class and binary classifications.

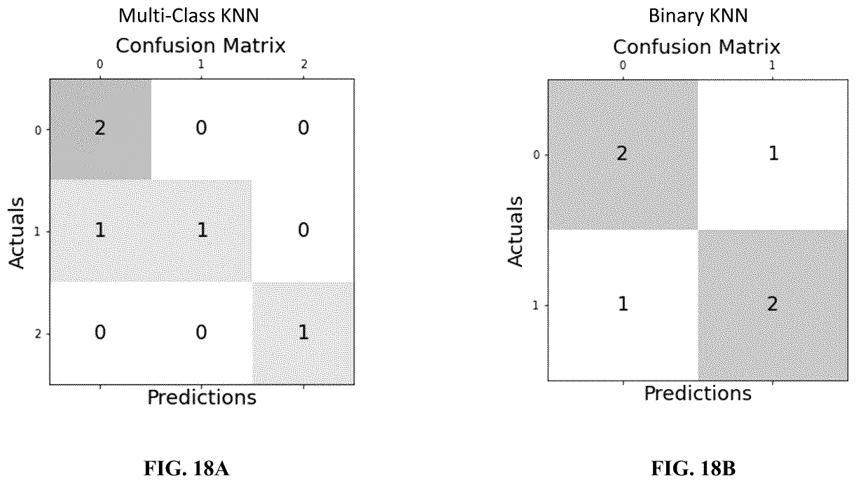

FIG. 18A illustrates a confusion matrix representing a multi-class classification of being unacceptable, being acceptable and being great for Protein A protein incorporated into non-dairy milk in the validation dataset, predicted by k-NN model. The predicted classifications of four validation samples are aligned with their respective ground truths. Only one sample shows some discrepancy between the ground truth classification (i.e., being acceptable) and predicted classification (i.e., being unacceptable).

FIG. 18B illustrates a confusion matrix representing a binary classification of being unacceptable and being acceptable for Protein A protein incorporated into non-dairy milk in the validation dataset, predicted by k-NN model. When the classification is reduced from multi-class to binary class, the k-NN model shows slight degradation in performance. The predicted classifications of four validation samples are aligned with their respective ground truth. Two samples show discrepancies between the ground truth and prediction.

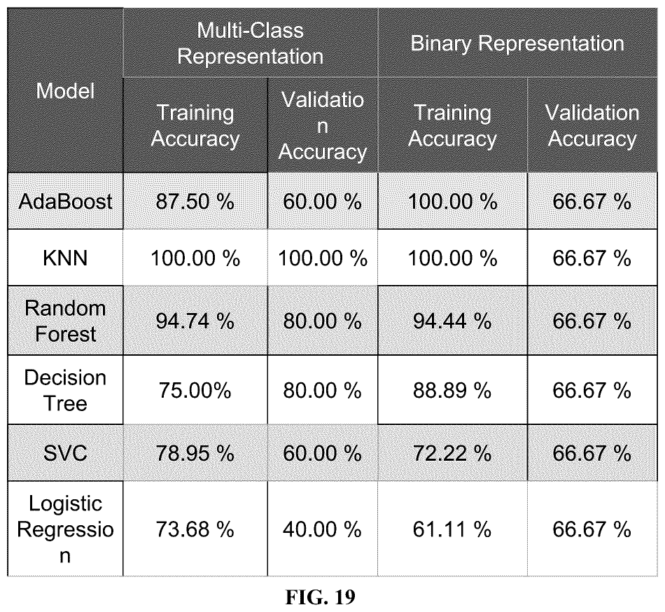

FIG. 19 lists the accuracy for multi-class classification and binary classification for Protein A protein incorporated into non-dairy milk in the validation dataset using various machine learning models, when human sensory features are excluded. Compared to the accuracy results where human sensory features are included illustrated in FIG. 17, the k-NN model shows improvement in validation accuracy for multi-class classification (from 80% to 100%). The random forest model also shows significant improvement in training and validation accuracies for both multi-class and binary classifications.

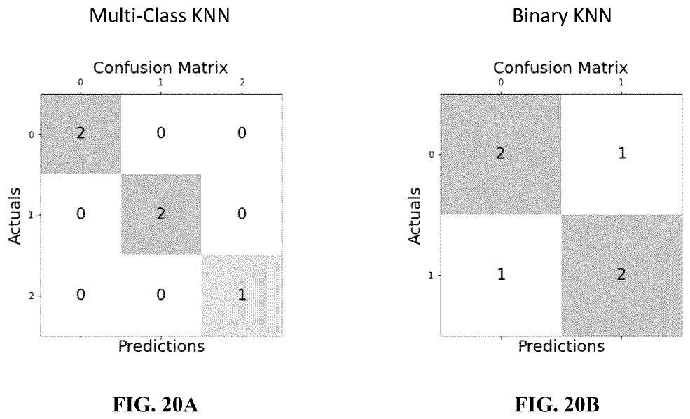

FIG. 20A illustrates a confusion matrix representing multi-class classification of being unacceptable, being acceptable and being great for Protein A protein incorporated into non-dairy milk in the validation dataset when human sensory features are excluded, predicted by k-NN model. Compared to the confusion matrix as illustrated in FIG. 18A, the remaining Protein BI of human sensory features improves the prediction performance of k-NN model. Instead of discrepancy in prediction, all of the samples show consistency between the ground truth and prediction. FIG. 20B illustrates a confusion matrix representing a binary classification of being unacceptable and being acceptable for Protein A protein incorporated into non-dairy milk in the validation dataset when human sensory features are excluded, predicted by k-NN model. Compared to the confusion matrix as illustrated in FIG. 18B, the prediction performance for the binary classification remains the same after the human sensory features are removed.

In some embodiments, the non-dairy milk dataset may be further parsed into, for example, oat milk, almond milk and soy milk. With a more nuanced categorization, the machine learning models shows better prediction performance.

### Protein A—Containing Date Bars Performance Prediction Using Machine Learning Models

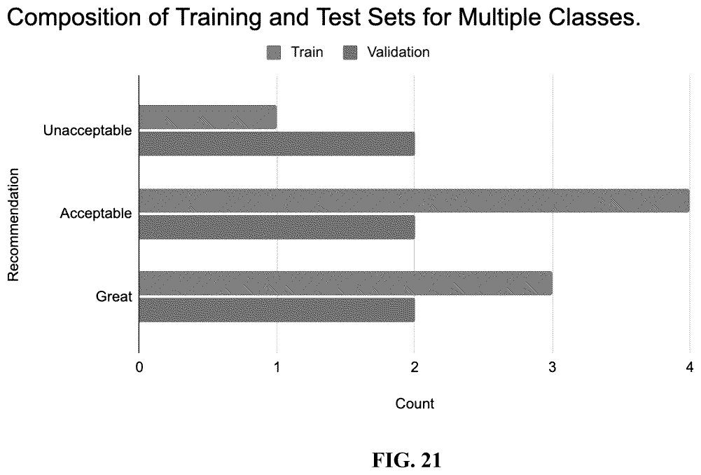

FIG. 21 illustrates compositions of training dataset and validation dataset for predicting the performance of Protein A protein incorporated into date bar. The training and validation data sets are labeled as “not recommended”, “good” and “great”, determined by subject area experts on the Application Team. Due to a high threshold of including date bar products into the training and validation sample pool, around 20% of the selected products have unacceptable performance.

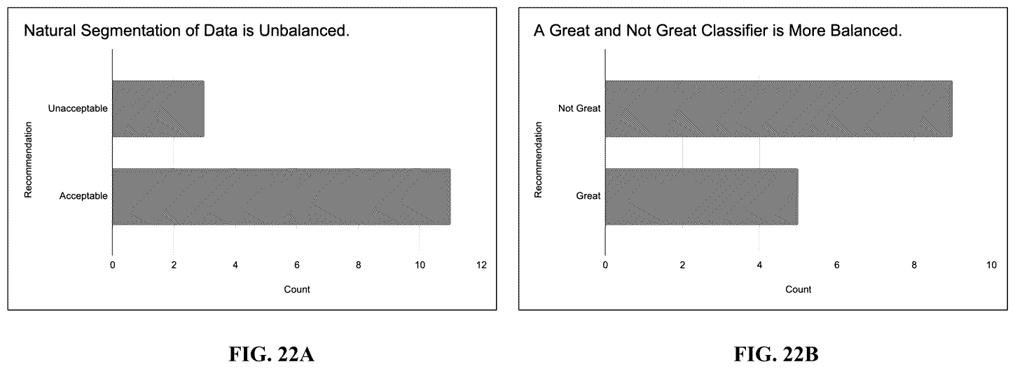

FIGS. 22A and 22B illustrate unbalanced natural segmentation of data and adjusted balanced segmentation of data, respectively. When the training and validation datasets are labeled as “unacceptable” and “acceptable” for the machine learning models to perform binary classification, the natural segmentation of data is unbalanced. As illustrated in FIG. 22A, natural segmentation of data results in an unbalanced set including 11 acceptable date bar samples and only 3 unacceptable samples. An adjustment to “not great” and “great” products will result in a more balanced segmentation of data. As illustrated in FIG. 22B, there are 5 great date bar samples and 9 not great samples.

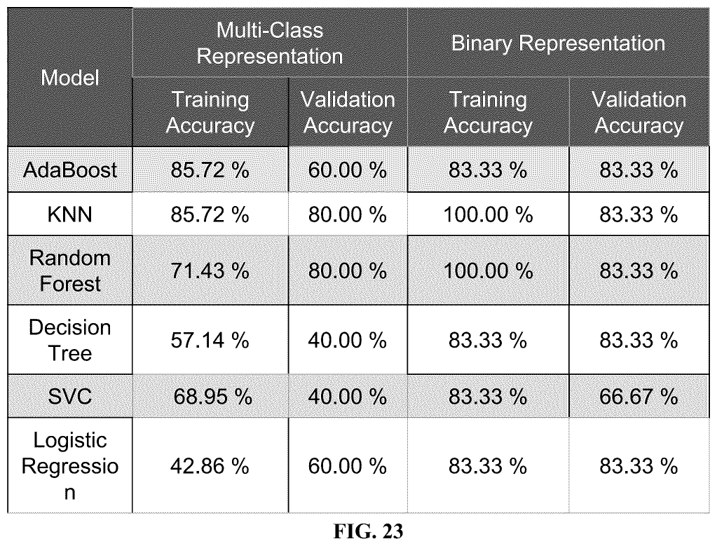

FIG. 23 lists the accuracy for multi-class classification and binary classification for Protein A protein incorporated into date bar in the validation dataset using various machine learning models, including AdaBoost, k-NN, random forest, decision tree, SVC and logistic regression models. Each model performs binary classification and multi-class (e.g., three-way) classification using a training dataset and validation dataset. Among others, k-NN model shows satisfactory training accuracy and validation accuracy in multi-class classification. All models show satisfactory accuracy in binary classification. It is expected that the accuracy will further be improved using a larger number of training and validation datasets.

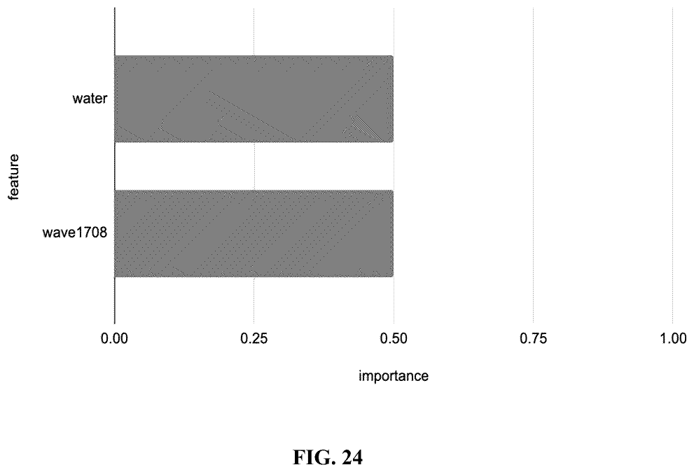

FIG. 24 illustrates feature importance for binary classification using AdaBoost model to predict the performance of Protein A protein incorporated into date bar. The amount of water in the formulation is as important as the FTIR data (wave1708).

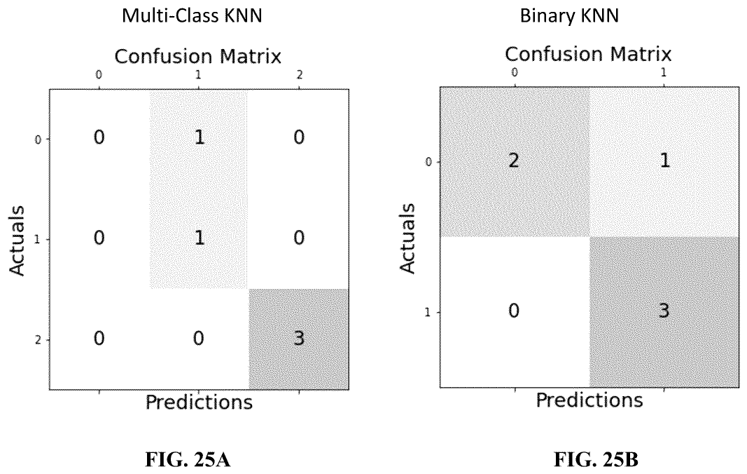

FIG. 25A illustrates a confusion matrix representing a multi-class classification of being unacceptable, being acceptable and being great for Protein A protein incorporated into date bar in the validation dataset, predicted by k-NN model. The predicted classifications of four validation samples are aligned with their respective ground truth. Only one sample shows some discrepancy between the ground truth classification (i.e., being unacceptable) and predicted classification (i.e., being acceptable).

FIG. 25B illustrates a confusion matrix representing a binary classification of being “not great” and being “great” for Protein A protein incorporated into date bar in the validation dataset, predicted by k-NN model. The predicted classifications of five validation samples are aligned with their respective ground truth. Only one sample shows some discrepancy between the ground truth classification (i.e., not great) and predicted classification (i.e., great).

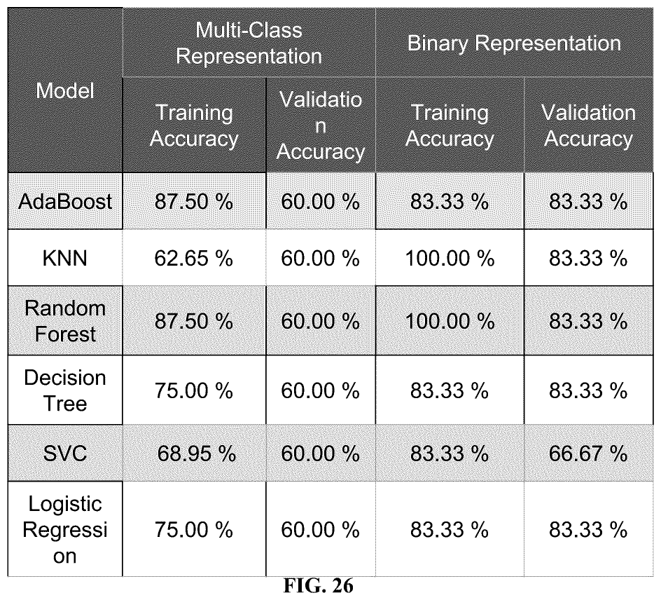

FIG. 26 lists the accuracy for multi-class classification and binary classification for Protein A protein incorporated into date bar in the validation dataset using various machine learning models, when human sensory features are excluded. Compared to the accuracy results where human sensory features are included illustrated in FIG. 23, the logistic regression model shows significant improvement in training accuracy for multi-class classification. The improvement suggests when treating sensory features as latent variables, the problem can be more linear.

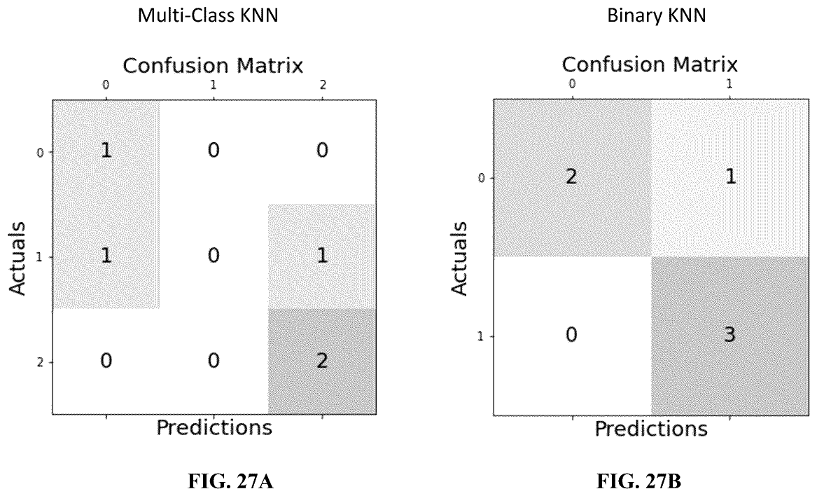

FIG. 27A illustrates a confusion matrix representing a multi-class classification of being unacceptable, being acceptable and being great for Protein A protein incorporated into date bar in the validation dataset predicted by k-NN model, excluding human sensory features. The predicted classifications of four validation samples are aligned with their respective ground truth. Two sample show some discrepancy between the ground truth and predicted classification. FIG. 27B illustrates a confusion matrix representing a binary classification of being “not great” and being “great” for Protein A protein incorporated into date bar in the validation dataset, predicted by k-NN model, excluding human sensory features. Compared to the confusion matrix as illustrated in FIG. 25B, the prediction performance for the binary classification remains the same after the human sensory features are removed.

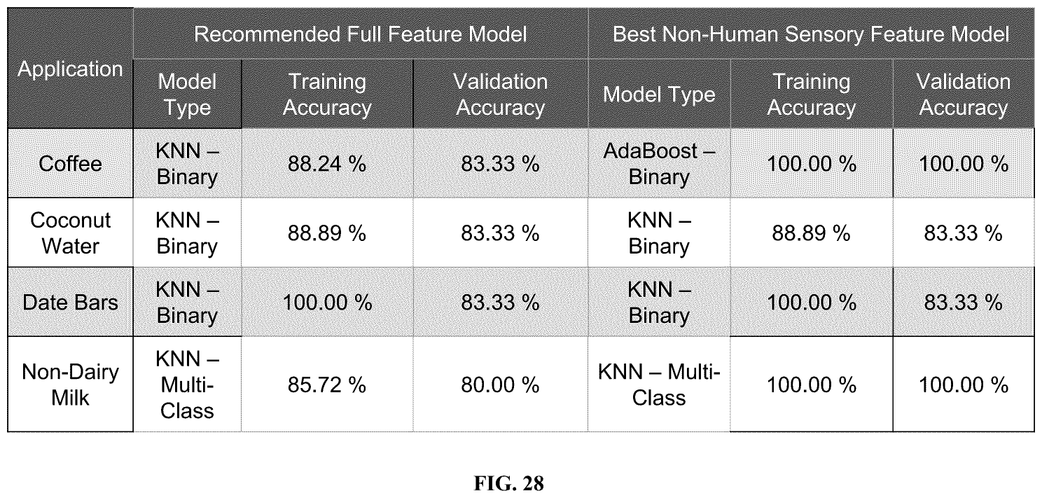

FIG. 28 compares the training accuracy and validation accuracy for predicting the performance of Protein A protein incorporated into various applications, using a full feature list for machine learning models to predict and a feature list removing human sensory features, respectively. A full feature list includes human sensory features obtained from in-house sensory panel. Removing the features that depend on human sensory panels shows no degradation in the prediction performance. For example, the binary k-NN model shows identical training accuracy and validation accuracy for predicting coconut water and date bar quality, regardless of the inclusion of human sensory features. Removing human sensory features may further improve the prediction performance. For example, the multi-class k-NN model shows significantly improved training and validation accuracy when human sensory features are excluded.

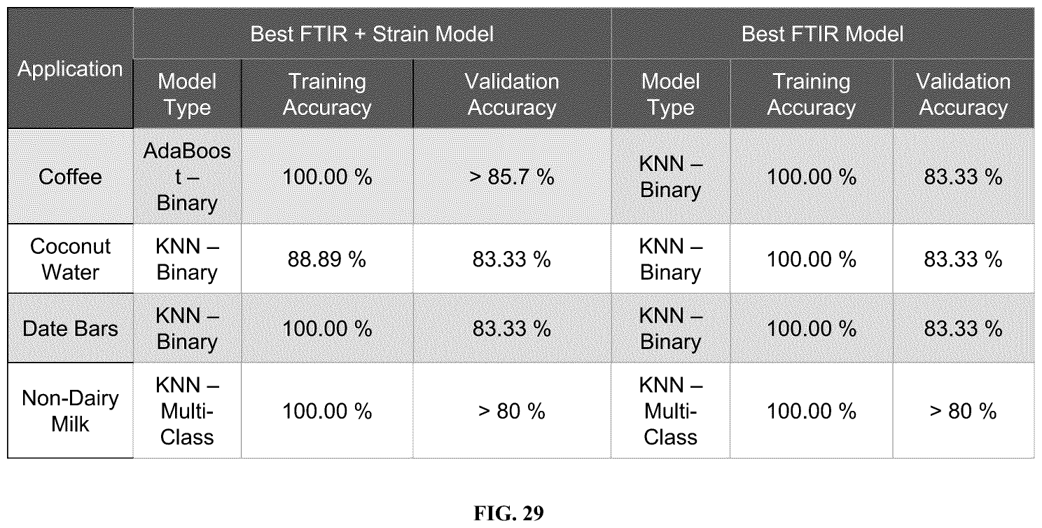

FIG. 29 compares the training accuracy and validation accuracy for predicting the performance of Protein A protein incorporated into various applications, using FTIR data for machine learning models to predict and additionally strain information of the Protein A protein, respectively. In one embodiment, the Protein A protein is manufactured via fermentation process and thus, the information associated with production strains can impact the Protein A product (see 314 and 324 in FIG. 3). Here, strain information is used in addition to FTIR data for the machine learning models to predict the application performance. As illustrated, the addition of strain information appears to show a minimal impact to the prediction accuracy. It also demonstrates the FTIR data provides a vast amount of information regarding the product, which can be used to predict its performance when incorporated into a given application.

### Protein B—Containing Application Performance Prediction Using Machine Learning Models

The following examples describe performance prediction of Protein B ovalbumin (Protein B)—containing products using machine learning models. Protein B is incorporated into different applications for consumption as food, where the applications include pound cakes, scrambles, macaron shells, vegan burgers, bimbo pound cakes, unbaked protein bars and baked protein bars. The machine learning models process FTIR data associated with generation of Protein B, and predict the performance or quality of the Protein B protein incorporated in these applications.

It should be noted that the following applications of food and beverage incorporated with Protein B protein are non-limiting examples that describe the present technology. Other example applications may include burger bindings, macarons/meringues and scrambles.

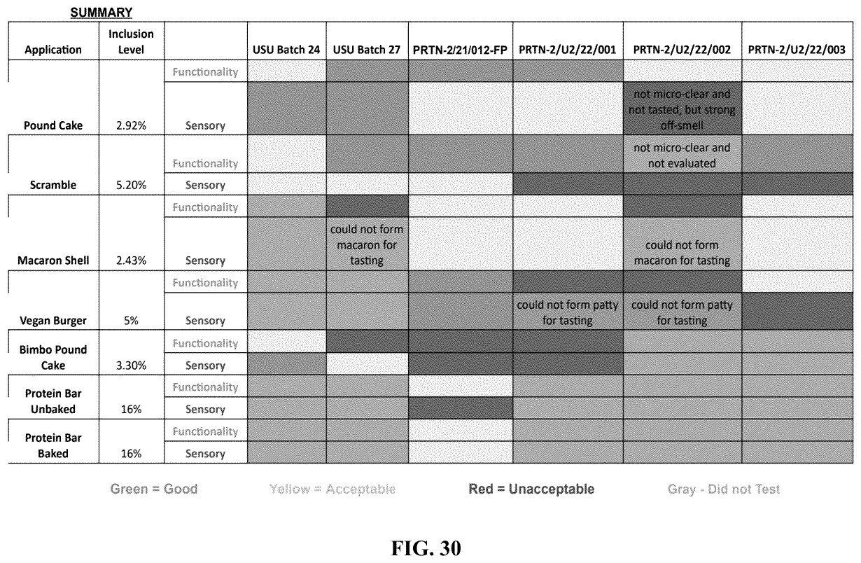

FIG. 30 is a summary of application ratings determined by subject area experts, where various applications are incorporated with Protein B protein from different manufacturing batches. The applications include incorporating the protein into pound cakes, scrambles, macaron shells, vegan burgers, bimbo pound cakes, unbaked protein bars and baked protein bars, where a range of about 2% to about 16% of Protein B protein from six different manufacturing batches is incorporated into these applications. The ratings are determined by subject area experts. The green label has a rating of “good”, indicating the sample is very similar to or better than the control in volume/texture and is free of off-smell or off-flavor. The yellow label has a rating of “acceptable”, indicating the sample matches the height of control but not matching the texture. The sample barely has any off-smell and/or off-flavor. The red label has a rating of “unacceptable”, indicating the sample is very different from the control in both height and texture. The sample also has a noticeable off-smell and/or off-flavor.

The subject area experts may comprise a panel of human raters who taste or test or consume one or more of the food products. In some embodiments, the panel of human raters may comprise at least 5 human raters, at least 10 human raters, at least 20 human raters, at least 50 human raters, at least 100 human raters, at least 200 human raters, at least 300 human raters, at least 400 human raters, at least 500 human raters, at least 600 human raters, at least 700 human raters, at least 800 human raters, at least 900 human raters, at least 1000 human raters or more. The food scrambles described herein may include any of the scrambles, e.g., egg-like products, described in PCT/US2022/017580, which is incorporated herein by reference in its entirety.

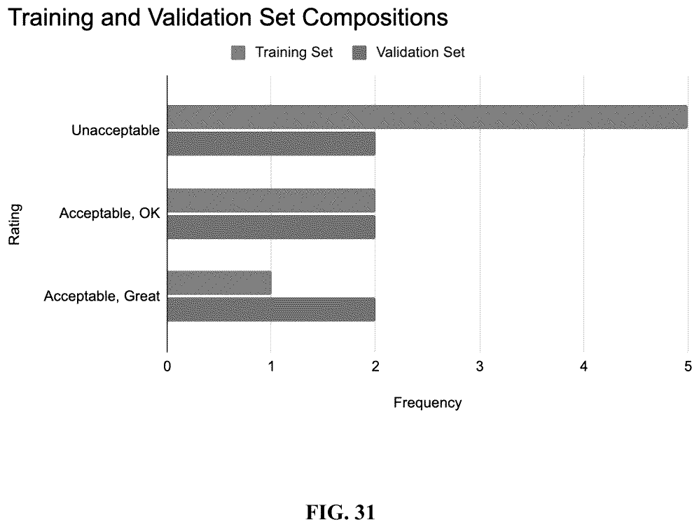

FIG. 31 illustrates compositions of training dataset and validation dataset for predicting the performance of Protein B protein incorporated into pound cake. The training and validation datasets include three different pound cake formulations and are stratified to obtain a balanced validation dataset.

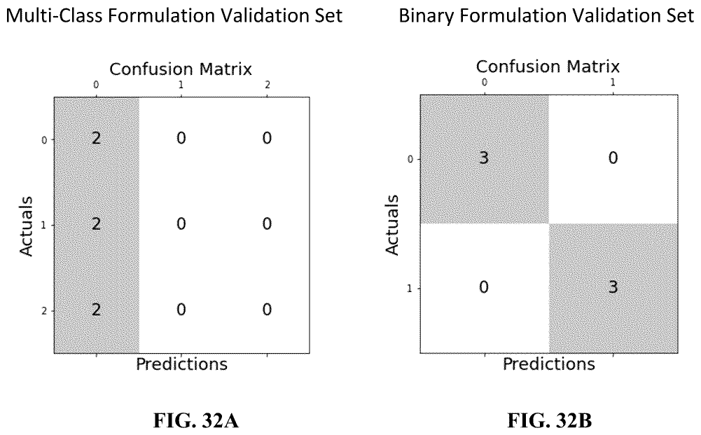

FIG. 32A illustrates a confusion matrix representing a multi-class classification of being unacceptable, being acceptable and being great for the performance of Protein B protein incorporated into pound cake in the validation dataset, predicted by a logistic regression model.

FIG. 32B illustrates a confusion matrix representing a binary classification of being unacceptable and being acceptable for the performance of Protein B protein incorporated into pound cake in the validation dataset, predicted by logistic regression model. The model shows a satisfactory validation accuracy for binary classification.

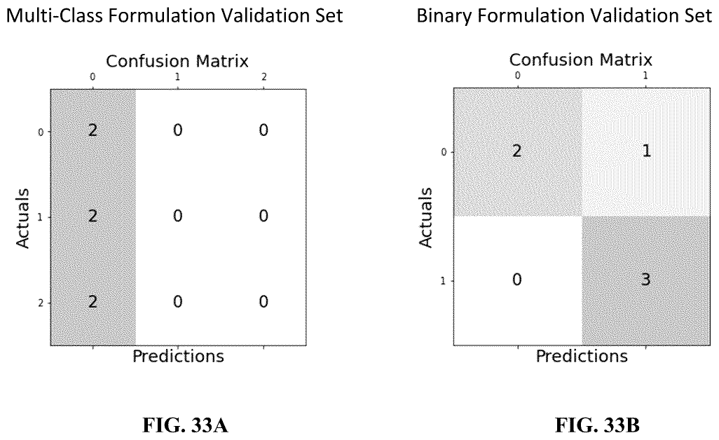

FIG. 33A illustrates a confusion matrix representing a multi-class classification of being unacceptable, being acceptable and being great for the performance of Protein B protein incorporated into pound cake in the validation dataset, predicted by a support vector classifier (SVC) model. The model shows unsatisfactory prediction performance for multi-class classification.

FIG. 33B illustrates a confusion matrix representing a binary classification of being unacceptable and being acceptable for the performance of Protein B protein incorporated into pound cake in the validation dataset, predicted by SVC model. Compared to multi-class classification, the validation accuracy for binary classification is increased to 85%.

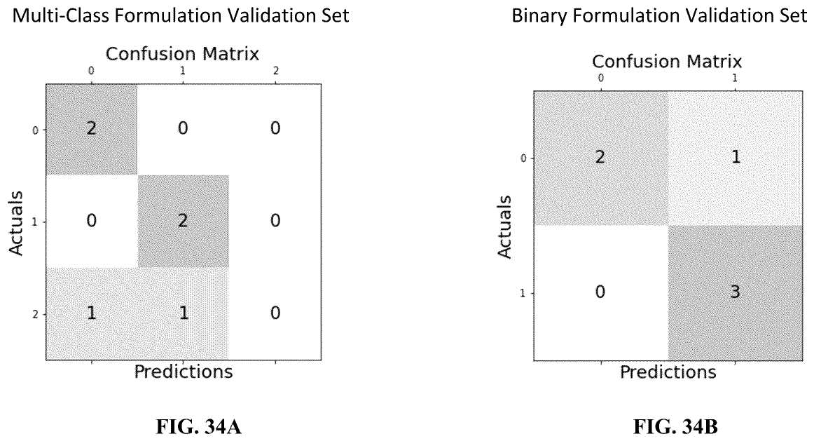

FIG. 34A illustrates a confusion matrix representing a multi-class classification of being unacceptable, being acceptable and being great for the performance of Protein B protein incorporated into pound cake in the validation dataset, predicted by k-NN model. When posed as a multi-class question, the validation accuracy for the k-NN model is 66.67% whereas the training accuracy is 100%. The k-NN model predicts the validation samples labeled as “great” to be either “unacceptable” or merely “acceptable.”

FIG. 34B illustrates a confusion matrix representing a binary classification of being unacceptable and being acceptable for the performance of Protein B protein incorporated into pound cake in the validation dataset, predicted by k-NN model. When posed as a binary question, the validation accuracy is 83.33% while the training accuracy is 100%.

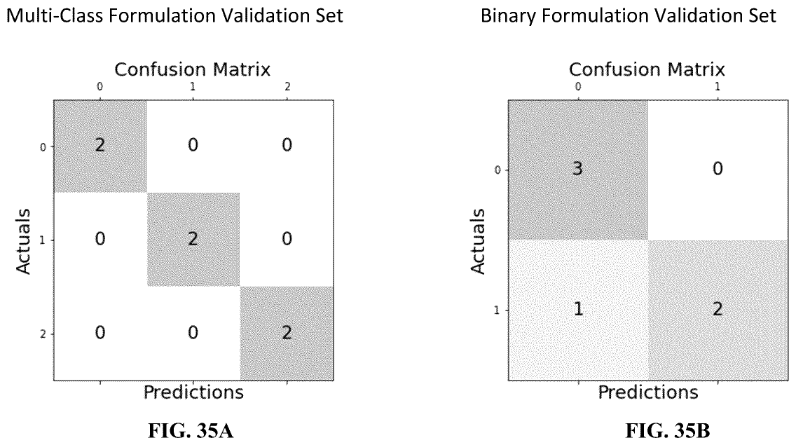

FIG. 35A illustrates a confusion matrix representing a multi-class classification of being unacceptable, being acceptable and being great for Protein B protein incorporated into pound cake in the validation dataset, predicted by a decision tree model. When posed as a multi-class problem, both the validation accuracy and training accuracy are 100% for the decision tree model.

FIG. 35B illustrates a confusion matrix representing a binary classification of being unacceptable and being acceptable for Protein B protein incorporated into pound cake in the validation dataset, predicted by a decision tree model. When posed as a binary problem, the validation accuracy is 83.33% whereas the training accuracy is 100%.

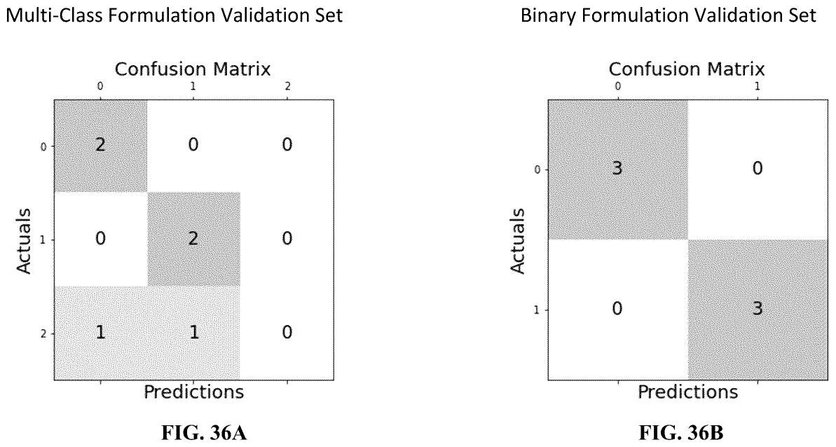

FIG. 36A illustrates a confusion matrix representing a multi-class classification of being unacceptable, being acceptable and being great for Protein B protein incorporated into pound cake in the validation dataset, predicted by a random forest model. When posed as a multi-class question, the validation accuracy for the random forest model is 66.67% whereas the training accuracy is 100%. The random forest model predicts the validation samples labeled as “great” to be either “unacceptable” or merely “acceptable.”

FIG. 36B illustrates a confusion matrix representing a binary classification of being unacceptable and being acceptable for Protein B protein incorporated into pound cake in the validation dataset, predicted by a random forest model. Four hyperparameter configurations are used for this result. Both the validation accuracy and training accuracy are 100% for the random forest model.

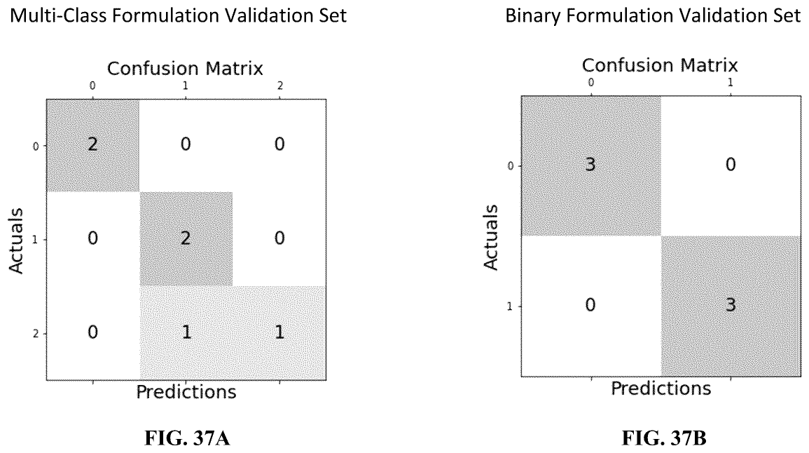

FIG. 37A illustrates a confusion matrix representing a multi-class classification of being unacceptable, being acceptable and being great for Protein B protein incorporated into pound cake in the validation dataset, predicted by AdaBoost model. When posed as a multi-class problem, validation set accuracy for the AdaBoost model is 83.33% while the training accuracy is 100%.

FIG. 37B illustrates a confusion matrix representing a binary classification of being unacceptable and being acceptable for Protein B protein incorporated into pound cake in the validation dataset, predicted by AdaBoost model. Over ten hyperparameter configurations are used for the model to determine the accuracy. Both the validation accuracy and training accuracy are 100% for the AdaBoost model. Thus, the performance of AdaBoost model exceeds other models in predicting the Protein B-containing pound cake quality.

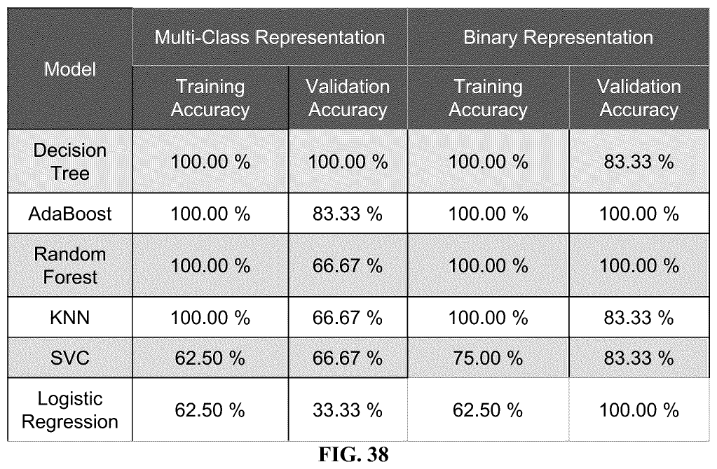

FIG. 38 lists the accuracy for binary and multi-class classification for Protein B protein incorporated into pound cake using various machine learning models. The decision tree model, AdaBoost model, random forest model and k-NN model show satisfactory training accuracy and validation accuracy for both multi-class and binary classifications.

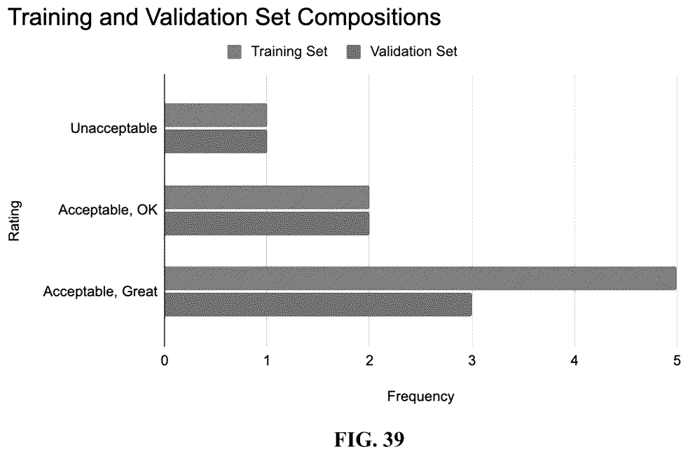

FIG. 39 lists compositions of collected sensory dataset as training dataset and validation dataset for predicting the performance of Protein B protein incorporated into pound cake. The sensory dataset shows imbalance. For example, both the training and validation datasets labeled as “unacceptable” only have a single sample.

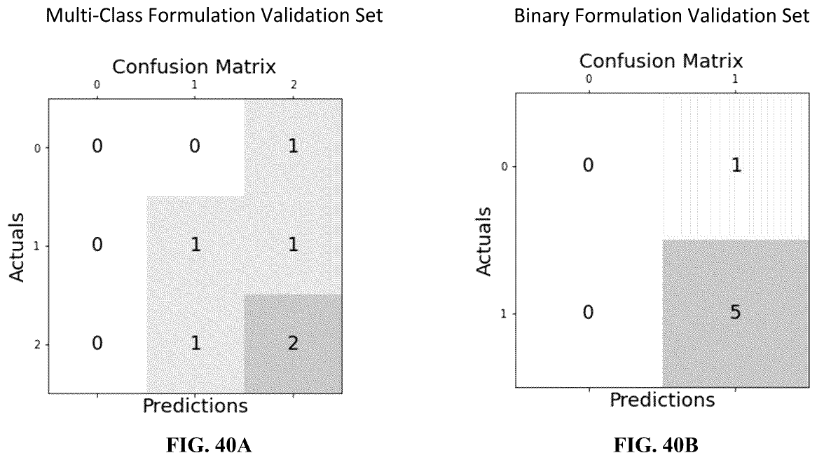

FIG. 40A illustrates a confusion matrix representing a multi-class classification of being unacceptable, being acceptable and being great for Protein B protein incorporated into pound cake in the collected sensory validation dataset, predicted by logistic regression model. The model shows unsatisfactory performance in the multi-class classification, with a validation accuracy of 50% and a training accuracy of 100%. FIG. 40B illustrates a confusion matrix representing a binary classification of being unacceptable and being acceptable for Protein B protein incorporated into pound cake in the collected sensory validation dataset, predicted by logistic regression model. When posed as a binary problem, the validation accuracy of the model is 83.33%, and the training accuracy is 85.75%.

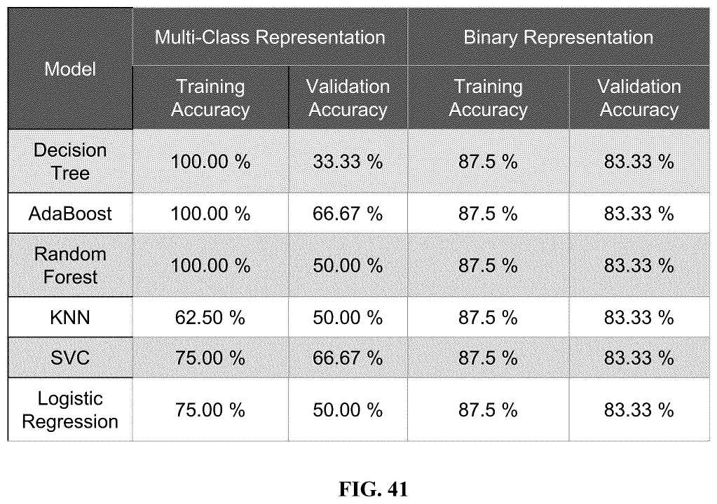

FIG. 41 lists the accuracy for binary and multi-class classification of Protein B protein incorporated into pound cake in the collected sensory validation dataset using various machine learning models. All the models show satisfactory training and validation accuracies for binary classification. Considering 14% of the samples have unacceptable sensory as illustrated in FIG. 39, it is likely that the model reaches 86% accuracy simply by predicting a sample as being acceptable in the binary classification. For multi-class classification, the models have unsatisfactory validation accuracy, caused by imbalance in the sensory class. Thus, it is important to have balanced samples.

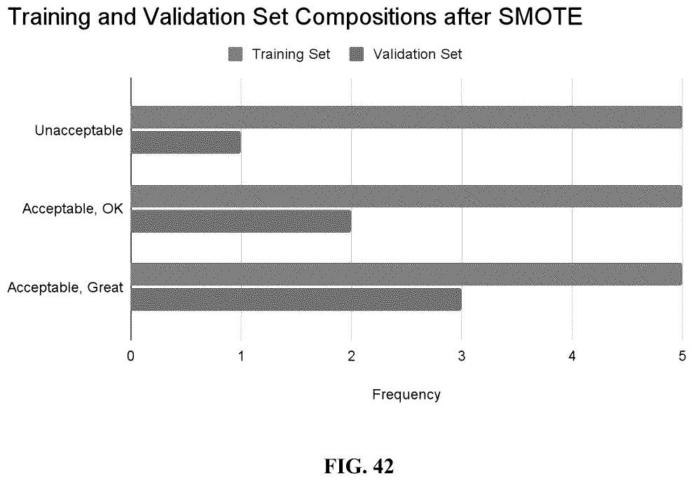

In some embodiments, the sensory class imbalance is addressed using Systematic Oversampling TEchnique (SMOTE). FIG. 42 lists compositions of collected sensory dataset as training dataset and validation dataset after SMOTE for predicting the performance of Protein B protein incorporated into pound cake. After the SMOTE process, the training and validation datasets show balance. The validation set in FIG. 42 increases by one sample because both of the unacceptable samples as illustrated in FIG. 39 are needed in the training set to run SMOTE. This leaves no real samples to be used in the validation dataset. To address this, a “prototypical unacceptable” sample is made by averaging the two unacceptable samples which happen to both use the same recipe, based on the assumption that the average of two unacceptable samples may accurately represent an unacceptable sensory sample.

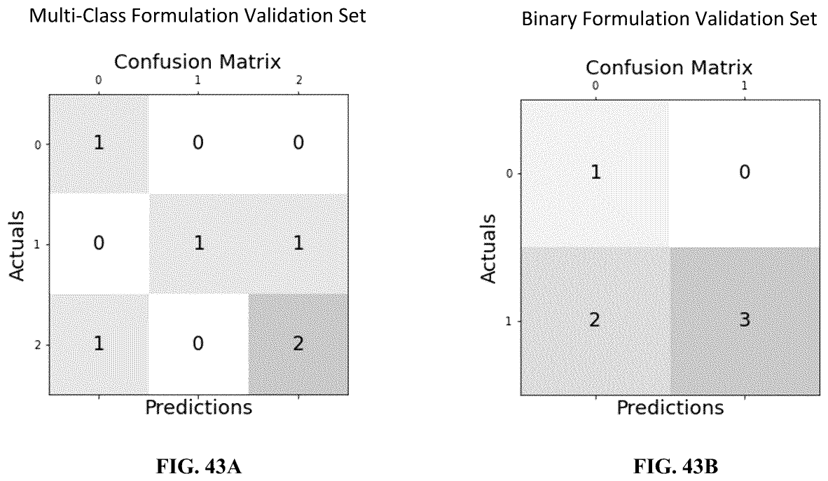

FIG. 43A illustrates a confusion matrix representing a multi-class classification of being unacceptable, being acceptable and being great for Protein B protein incorporated into pound cake in the balanced validation dataset after SMOTE, predicted by logistic regression model. The model shows unsatisfactory performance in the multi-class classification, with a validation accuracy of 66.67%. FIG. 43B illustrates a confusion matrix representing a binary classification of being unacceptable and being acceptable for Protein B protein incorporated into pound cake in the balanced validation dataset after SMOTE, predicted by logistic regression model. When posed as a binary problem, the validation accuracy of the model is 66.67%, and the training accuracy is 71.43%.

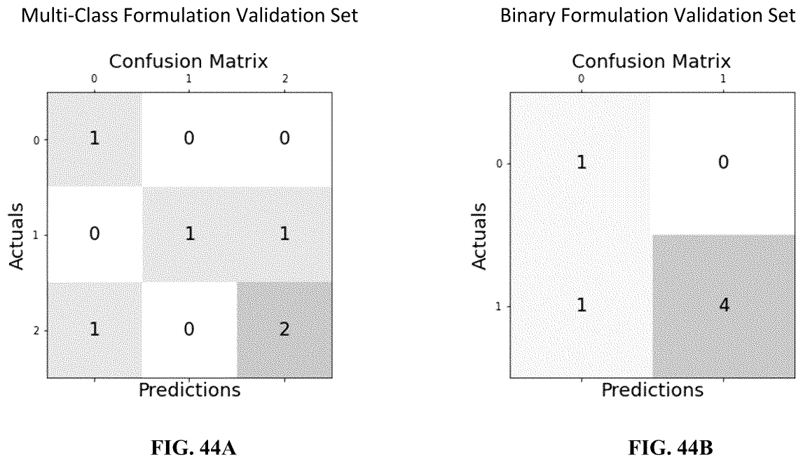

FIG. 44A illustrates a confusion matrix representing a multi-class classification of being unacceptable, being acceptable and being great for Protein B protein incorporated into pound cake in the balanced validation dataset after SMOTE, predicted by SVC model. FIG. 44B illustrates a confusion matrix representing a binary classification of being unacceptable and being acceptable for Protein B protein incorporated into pound cake in the balanced validation dataset after SMOTE, predicted by SVC model. When posed as a binary problem, the validation accuracy of the model is 83.33%, and the training accuracy is 100%.

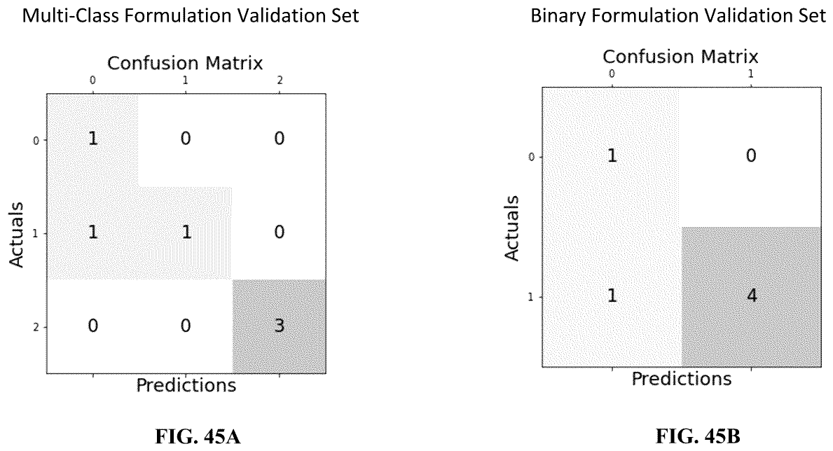

FIG. 45A illustrates a confusion matrix representing a multi-class classification of being unacceptable, being acceptable and being great for Protein B protein incorporated into pound cake in the balanced validation dataset after SMOTE, predicted by k-NN model. The model shows satisfactory performance in the multi-class classification, with a validation accuracy of 83.33%. One sample has discrepancy between its ground truth label (i.e., acceptable) and the prediction (i.e., unacceptable). The training set had a higher accuracy of 100%. FIG. 45B illustrates a confusion matrix representing a binary classification of being unacceptable and being acceptable for Protein B protein incorporated into pound cake in the balanced validation dataset after SMOTE, predicted by k-NN model. When posed as a binary problem, the validation accuracy of the model is 83.33%, and the training accuracy is 100%. The same sample shows discrepancy between its ground truth label (i.e., acceptable) and the prediction (i.e., unacceptable). It is therefore likely that this sample is at the boundary between being acceptable and unacceptable.

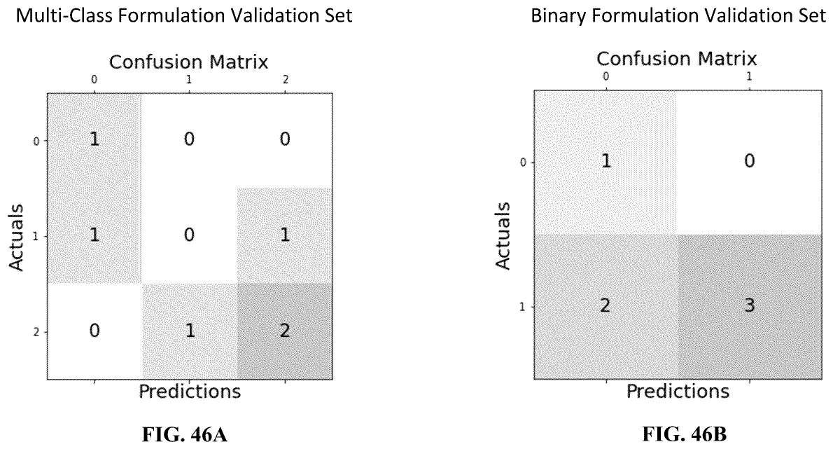

FIG. 46A illustrates a confusion matrix representing a multi-class classification of being unacceptable, being acceptable and being great for Protein B protein incorporated into pound cake in the balanced validation dataset after SMOTE, predicted by decision tree model.

FIG. 46B illustrates a confusion matrix representing a binary classification of being unacceptable and being acceptable for Protein B protein incorporated into pound cake in the balanced validation dataset after SMOTE, predicted by decision tree model. When posed as a binary problem, the validation accuracy of the model is 66.67%, and the training accuracy is 100%.

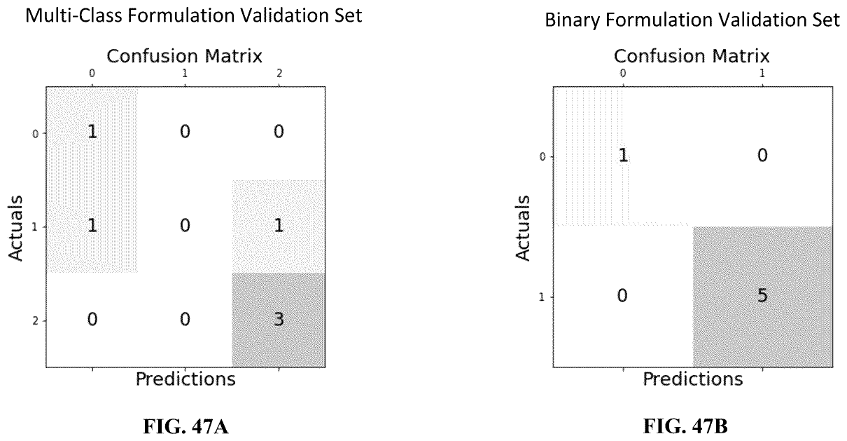

FIG. 47A illustrates a confusion matrix representing a multi-class classification of being unacceptable, being acceptable and being great for Protein B protein incorporated into pound cake in the balanced validation dataset after SMOTE, predicted by random forest model.

FIG. 47B illustrates a confusion matrix representing a binary classification of being unacceptable and being acceptable for Protein B protein incorporated into pound cake in the balanced validation dataset after SMOTE, predicted by random forest model. When posed as a binary problem, the validation accuracy of the model is 100%, and the training accuracy is slightly lower at 85.74%.

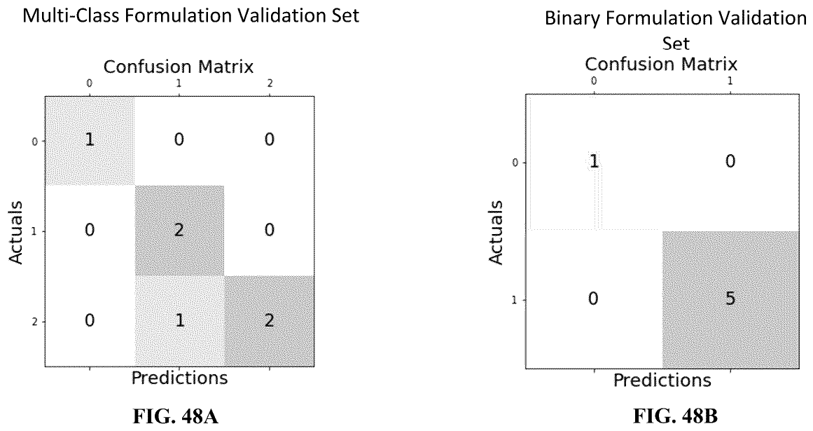

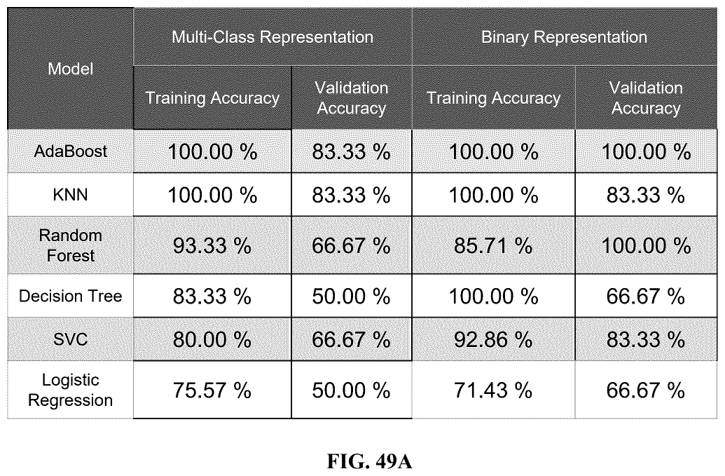

FIG. 48A illustrates a confusion matrix representing a multi-class classification of being unacceptable, being acceptable and being great for Protein B protein incorporated into pound cake in the balanced validation dataset after SMOTE, predicted by AdaBoost model. The model shows satisfactory performance in the multi-class classification, with a validation accuracy of 83.33% and training accuracy of 100%. FIG. 48B illustrates a confusion matrix representing a binary classification of being unacceptable and being acceptable for Protein B protein incorporated into pound cake in the balanced validation dataset after SMOTE, predicted by AdaBoost model. When posed as a binary problem, both the validation accuracy and training accuracy of the model are 100%.

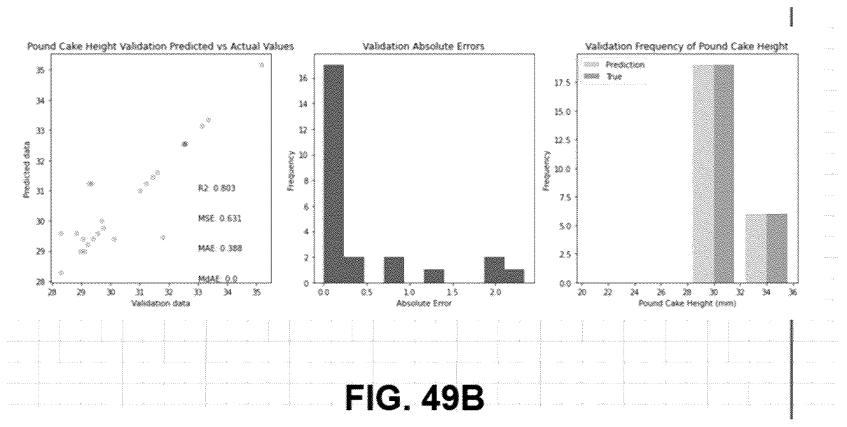

FIG. 49 lists the accuracy for binary and multi-class classification of Protein B protein incorporated into pound cake with a balanced sensory dataset after SMOTE using various machine learning models. The AdaBoost model, k-NN model, random forest model, decision tree model and SVC model show satisfactory training accuracy and validation accuracy. The SMOTE resolves the class imbalance problem and makes the sensory model tractable.

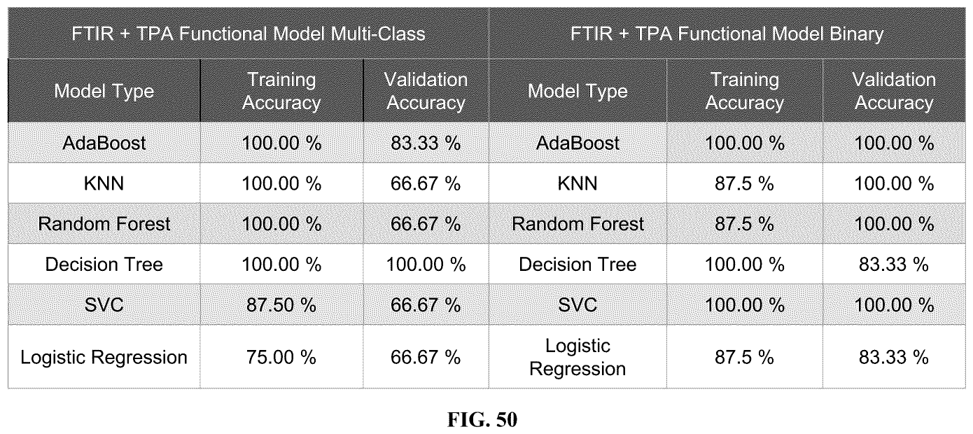

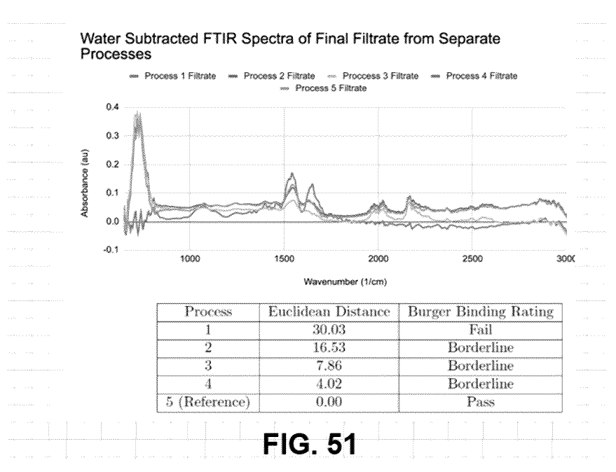

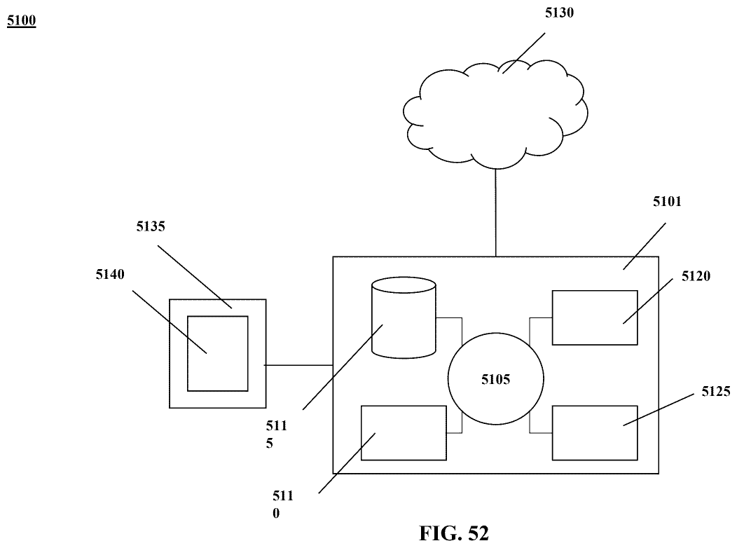

In some embodiments, text profile analysis (TPA) features are processed by the machine learning model to predict the application performance, in addition to FTIR data. FIG. 50 compares the training accuracy and validation accuracy for predicting performance of Protein B protein incorporated into various applications using FTIR data for machine learning models to predict and additionally TPA features, respectively. The inclusion of TPA features improve the prediction performance of the AdaBoost model, k-NN model, random forest model, SVC model and logistic regression model.

### Computer Systems

The present disclosure provides computer systems that are programmed to implement methods of the disclosure. FIG. 51 shows a computer system 5101 that is programmed or otherwise configured to predict application performance and/or quality. The computer system 5101 can regulate various aspects of machine learning analysis of FTIR spectra of the present disclosure, such as, for example, implementing one or more machine learning algorithms. The computer system 5101 can be an electronic device of a user or a computer system that is remotely located with respect to the electronic device. The electronic device can be a mobile electronic device.

The computer system 5101 includes a central processing unit (CPU, also “processor” and “computer processor” herein) 5105, which can be a single core or multi core processor, or a plurality of processors for parallel processing. The computer system 5101 also includes memory or memory location 5110 (e.g., random-access memory, read-only memory, flash memory), electronic storage unit 5115 (e.g., hard disk), communication interface 5120 (e.g., network adapter) for communicating with one or more other systems, and peripheral devices 5125, such as cache, other memory, data storage and/or electronic display adapters. The memory 5110, storage unit 5115, interface 5120 and peripheral devices 5125 are in communication with the CPU 5105 through a communication bus (solid lines), such as a motherboard. The storage unit 5115 can be a data storage unit (or data repository) for storing data. The computer system 5101 can be operatively coupled to a computer network (“network”) 5130 with the aid of the communication interface 5120. The network 5130 can be the Internet, an internet and/or extranet, or an intranet and/or extranet that is in communication with the Internet. The network 5130 in some cases is a telecommunication and/or data network. The network 5130 can include one or more computer servers, which can enable distributed computing, such as cloud computing. The network 5130, in some cases with the aid of the computer system 5101, can implement a peer-to-peer network, which may enable devices coupled to the computer system 5101 to behave as a client or a server.

The CPU 5105 can execute a sequence of machine-readable instructions, which can be embodied in a program or software. The instructions may be stored in a memory location, such as the memory 5110. The instructions can be directed to the CPU 5105, which can subsequently program or otherwise configure the CPU 5105 to implement methods of the present disclosure. Examples of operations performed by the CPU 5105 can include fetch, decode, execute, and writeback.

The CPU 5105 can be part of a circuit, such as an integrated circuit. One or more other components of the system 5101 can be included in the circuit. In some cases, the circuit is an application specific integrated circuit (A SIC).

The storage unit 5115 can store files, such as drivers, libraries and saved programs. The storage unit 5115 can store user data, e.g., user preferences and user programs. The computer system 5101 in some cases can include one or more additional data storage units that are external to the computer system 5101, such as located on a remote server that is in communication with the computer system 5101 through an intranet or the Internet.

The computer system 5101 can communicate with one or more remote computer systems through the network 5130. For instance, the computer system 5101 can communicate with a remote computer system of a user (e.g., a mobile device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 5101 via the network 5130.

Methods as described herein can be implemented by way of machine (e.g., computer processor) executable code stored on an electronic storage location of the computer system 5101, such as, for example, on the memory 5110 or electronic storage unit 5115. The machine executable or machine readable code can be provided in the form of software. During use, the code can be executed by the processor 5105. In some cases, the code can be retrieved from the storage unit 5115 and stored on the memory 5110 for ready access by the processor 5105. In some situations, the electronic storage unit 5115 can be precluded, and machine-executable instructions are stored on memory 5110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 5101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. M any of these forms of computer readable media may be involved in carrying one or more sequences of one or more instructions to a processor for execution.

The computer system 5101 can include or be in communication with an electronic display 5135 that comprises a user interface (UI) 5140 for providing, for example, visualizations comprising predictions of application performance and/or quality. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 5105. The algorithm can, for example, predict application performance and/or quality.

### Particular Implementations

Disclosed is a method for predicting product performance or quality. The method may comprise: (a) obtaining data associated with generation of one or more products. The data may comprise Fourier transform infrared (FTIR) data. The method may also comprise (b) processing the data using one or more machine learning models to generate a prediction of performance or quality of the one or more products when incorporated into one or more applications for consumption as food and/or beverage. The one or more applications may comprise a plurality of different applications for ovomucoid (Protein A). The one or more products may comprise at least one product in powder form. The one or more applications may comprise at least one food application or food type. The one or more products may be used as a binder in at least one food application or food type. The one or more applications may comprise at least one beverage application or beverage type. The one or more products may be used as a neutral protein in at least one beverage application or beverage type. The prediction of performance or quality may comprise one or more scores associated with one or more attributes for the one or more applications. The one or more attributes may comprise sensory attributes associated with sensory perception of the one or more applications. The sensory attributes may comprise flavor, texture, mouth feel, taste, odor or appearance. The one or more attributes may comprise functionality attributes associated with the incorporation of the one or more products into the one or more applications. The functionality attributes may relate to cooking functionality including gelation, foaming, scramble, baking, cooking experience, or appearance of food or beverage applications during preparation. The one or more scores may be predictive of a level of acceptance, acceptability or satisfaction to a group of consumers of the one or more applications for consumption as food and/or beverage. The FTIR data may comprise FTIR spectra of at least one powdered product. The FTIR data may comprise FTIR spectra of at least one aqueous product. The FTIR data may comprise FTIR spectra of at least one product comprising a powder and aqueous mixture. The data may further comprise rheological data. The data further may comprise strong cation exchange (SCX) chromatography data. The one or more machine learning models may be generated based at least in part on a plurality of features, an importance level or weight of each feature, and interactions between different features (causal inference or relationships). The plurality of features may comprise at least two of the following: FTIR spectrum, downstream processing (DSP) quality, upstream processing (USP) quality, flavor, or powder quality. One or more machine learning models comprise one or more linear or regression models. The one or more machine learning models comprise AdaBoost, K-nearest neighbor, random forest, decision tree, support vector, or a neural network. The one or more machine learning models may comprise at least one model that is trained using in part sensory data. The one or more machine learning models may comprise at least one model that is not trained using any sensory data. The FTIR data may be unaugmented. The FTIR data may be augmented with synthetically generated data comprising of simulated FTIR spectra and/or simulated noise. The synthetically generated data may be generated using a sampling algorithm. The sampling algorithm may comprise Synthetic Minority Oversampling Technique (SMOTE).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system for predicting a food performance or quality, comprising:
(a) a spectrometer configured to shine a beam comprising one or more frequencies of light on one or more products;
(b) a measuring device configured to measure the light absorption of the one or more products per wavelength of light by taking Fourier transform infrared (FTIR) data of the raw measurement data to create an interferogram;
(c) a computing device comprising one or more processors and memory configured to store executive instructions, wherein the instructions, when executed by the one or more processors, cause the one or more processors to:
obtain the FTIR data associated with generation of one or more products; and
process the FTIR data using one or more machine learning models to generate a prediction of performance or quality of the one or more products when incorporated into one or more applications for consumption as food and/or beverage.

2. The system of claim 1, wherein the one or more products comprise at least one product in powder form.

3. The system of claim 1, wherein the one or more applications comprise at least one food application or food type.

4. The system of claim 1, wherein the prediction of performance or quality comprises one or more scores associated with one or more attributes for the one or more applications.

5. The system of claim 10, wherein the one or more attributes comprise sensory attributes associated with sensory perception of the one or more applications.

6. The system of claim 11, wherein the sensory attributes comprise flavor, texture, mouth feel, taste, odor or appearance.

7. The system of claim 10, wherein the one or more attributes comprise functionality attributes associated with the incorporation of the one or more products into the one or more applications.

8. The system of claim 13, wherein the functionality attributes relate to cooking functionality including gelation, foaming, scramble, baking, cooking experience, or appearance of food or beverage applications during preparation.

9. The system of claim 10, wherein the one or more scores are predictive of a level of acceptance, acceptability or satisfaction to a group of consumers of the one or more applications for consumption as food and/or beverage.

10. The system of any of claims 10 through 15, wherein the prediction of performance or quality is generated independent of, without using, or prior to use of a human sensory panel.

11. The system of claim 1, wherein the FTIR data comprises FTIR spectra of at least one powdered product.

12. The system of claim 1, wherein the FTIR data comprises FTIR spectra of at least one aqueous product.

13. The system of claim 1, wherein the FTIR data comprises FTIR spectra of at least one product comprising a powder and aqueous mixture.

14. The system of claim 1, wherein the data further comprises rheological data.

15. The system of claim 1, wherein the data further comprises strong cation exchange (SCX) chromatography data.

16. The system of claim 1, wherein the one or more machine learning models are generated based at least in a part on a plurality of features, an importance level or weight of each feature, and interactions between different features (causal inference or relationships).

17. The system of claim 16, wherein the plurality of features comprise at least two of the following: FTIR spectrum, DSP quality, USP quality, flavor, powder quality, or functional assays applied to the one or more products.

18. The system of claim 1, wherein the one or more machine learning models comprise one or more classification models.

19. The system of claim 1, wherein the one or more machine learning models comprise AdaBoost, K-nearest neighbor, random forest, decision tree, support vector, or a neural network.

20. The system of claim 1, wherein the one or more machine learning models comprise at least one model that is trained using in part sensory data.

21. The system of claim 1, wherein the one or more machine learning models comprise at least one model that is not trained using any sensory data.

22. The system of claim 1, wherein the FTIR data is un-augmented.

23. The system of claim 1, wherein the FTIR data is augmented with synthetically generated data comprising of simulated FTIR spectra and/or simulated noise.

24. The system of claim 23, wherein the synthetically generated data is generated using a sampling algorithm.

25. The system of claim 24, wherein the sampling algorithm comprises Synthetic Minority Over-sampling Technique (SMOTE).

26. A data management system, comprising:
a data library configured to store datasets belonging to a domain, the datasets received from one or more data sources;
a data management platform operated by one or more computing devices, the one or more computing devices comprising one or more processors and memory configured to store executive instructions, wherein the instructions, when executed by the one or more processors, cause the one or more processors to perform a data management process, wherein the data management process comprises:
obtaining Fourier transform infrared (FTIR) data associated with generation of one or more products; and
processing the FTIR data using one or more machine learning models;
generating a prediction of performance or quality of the one or more products when incorporated into one or more applications for consumption as food and/or beverage.

27. The data management system of claim 26, wherein prediction of performance or quality comprises one or more scores associated with one or more attributes for the one or more applications.

28. The data management system of claim 27, wherein the prediction of performance or quality is generated independent of, without using, or prior to use of a human sensory panel.
